(19) United States
(12) Patent Application Publication
(10) Pub. No.: US 2002/0059126 A1
(43) Pub. Date: May 16, 2002

(54) System and method for a selecting an investment item

(76) Inventor: John Ricciardi, London (GB)

Correspondence Address: GOODWIN PROCTER & HOAR LLP, 7 BECKER FARM RD, ROSELAND, NJ, 07068, US

(21) Appl. No.: 09/892,958

(22) Filed: Jun. 27, 2001

Related U.S. Application Data
(60) Provisional application No. 60/214,754, filed on Jun. 27, 2000.

(51) Int. Cl. G06F 17/60

(52) U.S. Cl. 705/36

(57) ABSTRACT

A novel system and method for generating investment signals for investment items in a given set of investment items is described herein. One aspect of the present invention involves defining a set of rules that generate investment signals such as to “buy” or “sell”. These investment signals can be further scored with respect to a time period. Additional aspects of the present invention include further analyzing scoring the investment signals with the investment item's past price behavior and/or capitalization. Investment items identified in accordance with the present invention can be compared with other investment item scores and a portfolio may also be generated. These investment items may then be displayed in a manner helpful to the investment trader.

### RELATED UNITED STATES APPLICATIONS/CLAIM OF PRIORITY

This application is a non-provisional counterpart to, and claims the benefit of, co-pending U.S. Provisional Patent Application Ser. No. 60/214754, which was filed on Jun. 27, 2000 and entitled “Novel Web Site”. This application is also related to co-pending U.S. Patent Application Ser. No. [To Be Assigned], which was filed on Jun. 26, 2001 and entitled “Method For Classifying An Investment Item By Price Pattern”. The entire disclosures of the forgoing patent applications are hereby incorporated by reference as if set forth at length herein.

### FIELD OF INVENTION

The present invention relates to a novel system and method designed toward the need for generating buy and sell signals for a given investment item. More particularly, the present invention involves a novel analysis technique whereby investment items are grouped via respective unique historical price patterns over a user-selected period of time.

### BACKGROUND OF THE INVENTION

Presently, there are many web sites on the Internet and other data feeds that allow a user to access information regarding the U.S. investment markets. Typically, those web sites and data feeds provide market information such as the current price of a particular investment item or index (or even a list of investment items or indexes), or some historical information in the form of charts or graphs that display the price movement of a selected investment item over some period of time (i.e. year, month, 5-days, 3-days, 1-day) selected by the user. Though such information can be considered useful, it is extremely limited or difficult to understand.

Moreover, the information is usually provided only in set time periods and absent any useful context. For example, the historical prices of an investment item for the prior five day period may not be tremendously helpful to the investment trader interested in the investment's pattern over the course of the most recent few hours. Additionally, the basic historical pattern typically found in investment information-providing tools today provide only the raw historical numbers rather than providing price analysis trends specific to the investment traders desired time period. Further yet, the information and patterns do not, in and of themselves, assist the investment trader in determining whether to buy or sell a specific investment item, such as a security.

Accordingly, a primary object of the present invention is to provide a novel system and method of gathering and determining price pattern information, creating investment rules and generating investment signals, such as buy or sell, based upon the individual needs of an investment trader.

### SUMMARY OF THE INVENTION

In particular, the present invention discloses a system and method for establishing investment decision rules that will generate buy and sell signals for each security in a given universe of securities, allow the securities in the given universe to be scored and then ranked in order of probable investment return according to the rules, and permit the construction of model or actual portfolios based upon applications of the rankings derived from the rules.

The system and method are adapted to shorter and longer investment horizons by shortening and lengthening the measurements upon which the rules are based, and in some cases by changing the weightings of measurements used by the rules to reflect the shorter-term effects of consensus expectations and the longer-term effects of reported results.

The investment decision rules are based upon information from a number of sources, all of which are sets of published data. Rules derived from a subset of related data are called an investment strategy. The buy and sell signals generated for individual securities by applying those rules are called investment signals for that strategy. The individual security scores obtained by taking into account those investment signals are called security scores for that strategy. The ranking by security scores is called the security ranking for that strategy. The portfolios constructed by applying those security rankings are called portfolios for that strategy.

Summary of Strategies

Six strategies derived from subsets of related data are outlined as follows:

1. Price Pattern Strategy

These rules use measures of price movements as the basis for generating buy and sell signals for individual securities. All securities in the investment universe are put into price pattern categories as described above. In addition, other price information for each security concerning its recent volatility, its longer-term volatility, the direction and magnitude of its recent price changes, and the direction and magnitude of its longer-term price changes are used as inputs for generating the security's buy and sell signals for the Price Pattern Strategy.

2. Macroeconomic Strategy

These rules use measures of published macroeconomic data as the basis for generating buy and sell signals for individual securities. The macroeconomic data are divided into a number of categories according to economic domain such as Short-term Interest Rates, Long-term Interest Rates, Yield Curves, Yield Spreads, Money Supply, Exchange Rates, External Accounts, Prices, Industrial Activity, Consumer Activity and Unemployment. The macroeconomic data are further divided into categories according to the regions and countries to which they refer. Some regional categories are aggregates, such as Global, Europe, and Asia. The rules for the macroeconomic strategy use measurements of macroeconomic data from these categories to assess effects on broad groupings of securities such as regional indices, global sector indices, and global industry indices. The rules also use measurements of an individual security's sensitivity to changes in the overall index performance of the region, sector, and industry groupings to which the security is assigned. By measuring expectations and actual results for macroeconomic data, weighting these measurements by their prior effects on the investment performance of broad groupings of securities, and evaluating the sensitivity of individual securities to the broad groupings to which they are assigned, these rules generate buy and sell signals for individual shares according to the Macroeconomic Strategy.

3. Earnings Strategy

These rules use measures of published earnings reports and consensus earnings forecasts to generate buy and sell signals for individual securities. The changes in estimates of forward earnings, averages of changes in estimates of forward earnings, upgrades in estimates compared to downgrades in estimates, and the spread in estimates are used. Forward earnings estimate deciles by capitalisation and by global sector are used as well. By weighting such measures of forward earnings estimates, buy and sell signals for individual securities are generated for the Earnings Strategy.

4. Valuations Strategy

These rules use measurements obtained from the outputs of valuation models for individual securities. The valuation models for the individual securities can be dividend-discount models, cashflow-discount models, price/bookvalue models or any model based on individual security fundamentals. The process takes the high, low and central values output by a model for each security in a region, sector, or industry, then weights and aggregates the individual security values to obtain high, low and central values for the region, sector or industry group as a whole. The difference between the current price of a security and its values output by the model are compared to the differences between the current aggregate index prices and the aggregate model values for the region, sector and industry groups to which the individual security is assigned. By weighting these comparisons by the price sensitivity of securities to the region, sector and industry to which they are assigned, these rules generate buy and sell signals for the Valuations Strategy.

5. Risk Strategy

These rules use measurements obtained from the outputs of risk models for individual securities. The risk models for the individual securities can be models based on the security's past volatility, interest-expense/cashflow models, debt/equity models or any model based on individual security fundamentals. The process takes the risk measurement output by a model for each security in a region, sector, or industry, then weights and aggregates the individual security measures to obtain risk measures for the region, sector or industry group as a whole. The risk measurement output by the model for a security is compared to the aggregate model risk measurement for the region, sector and industry groups to which the individual security is assigned. By weighting these comparisons by the price sensitivity of securities to the region, sector and industry to which they are assigned, these rules generate buy and sell signals for the Risk Strategy.

6. Combined Strategy

The buy and sell signals for individual securities that are generated by the five foregoing strategies are combined into a further strategy that uses their aggregate measures. Each security's buy and sell signals from all the foregoing strategies are weighted and summed. The signals confirm, neutralize, or reverse themselves, generating a range of scores at a maximum when all point to buy, and at a minimum when all point to sell. The rules generate from these scores a single series of aggregate buy and sell signals for the Combined Strategy.

### BRIEF DESCRIPTIONS OF THE DRAWINGS

FIGS. 1-32 illustrate various novel and inventive aspects of the present invention presenting investment signals, scores and other information in accordance with various aspects of the present invention.

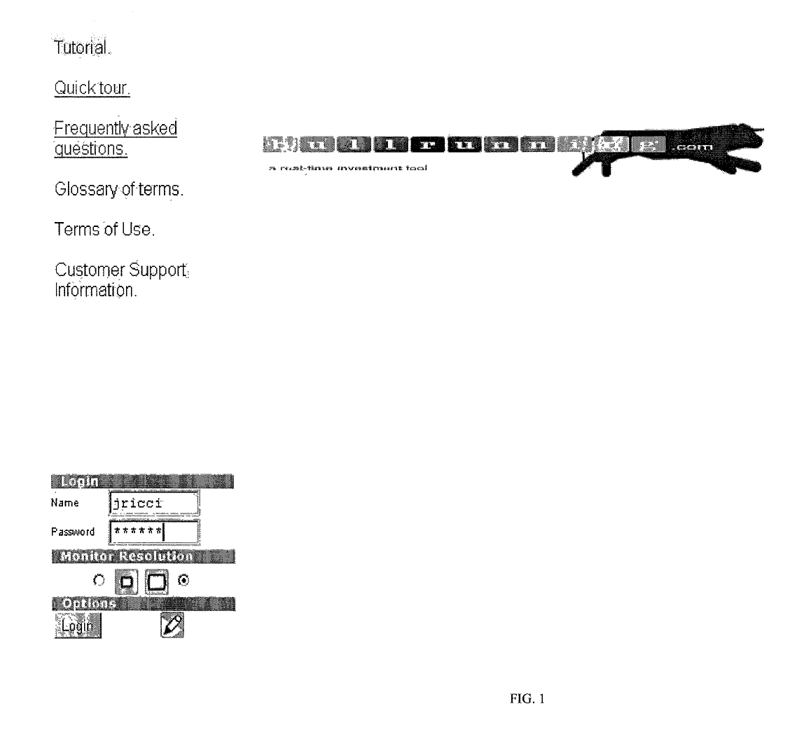

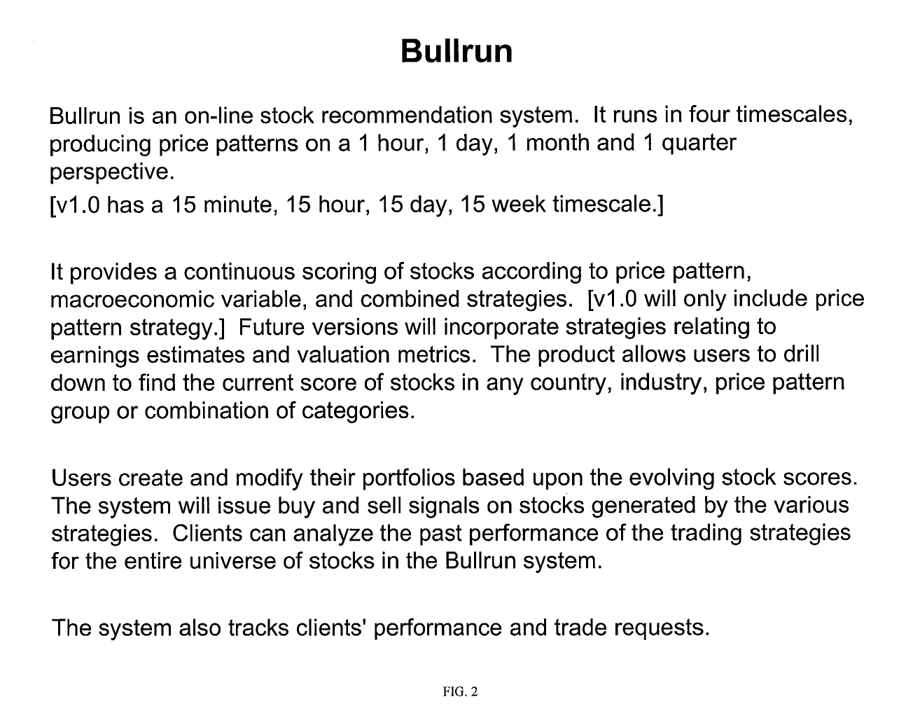

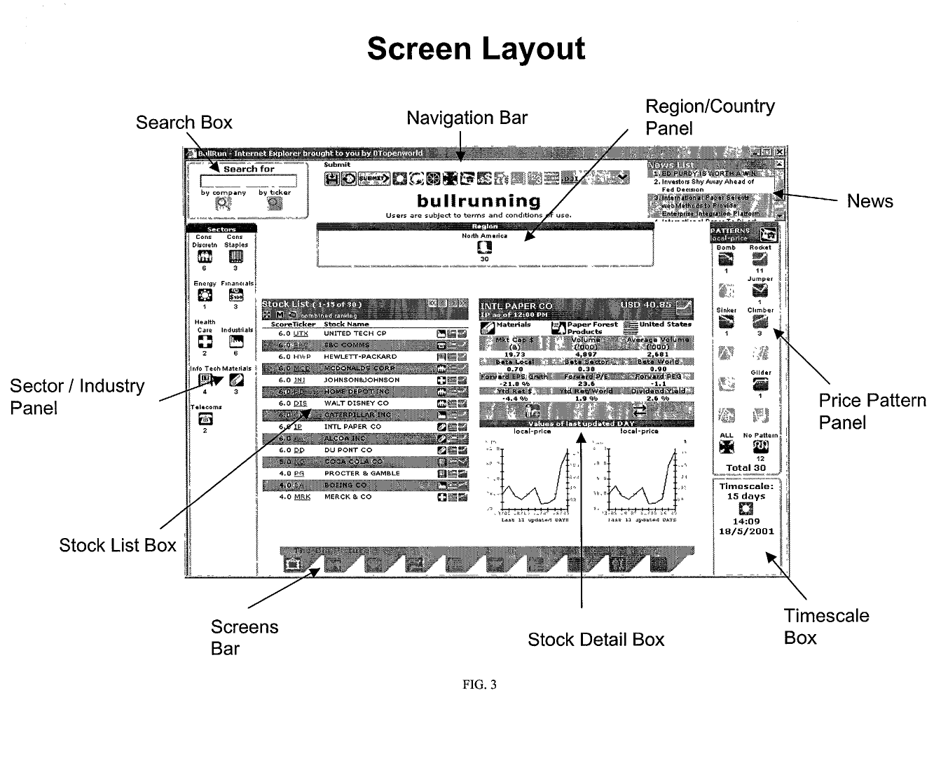

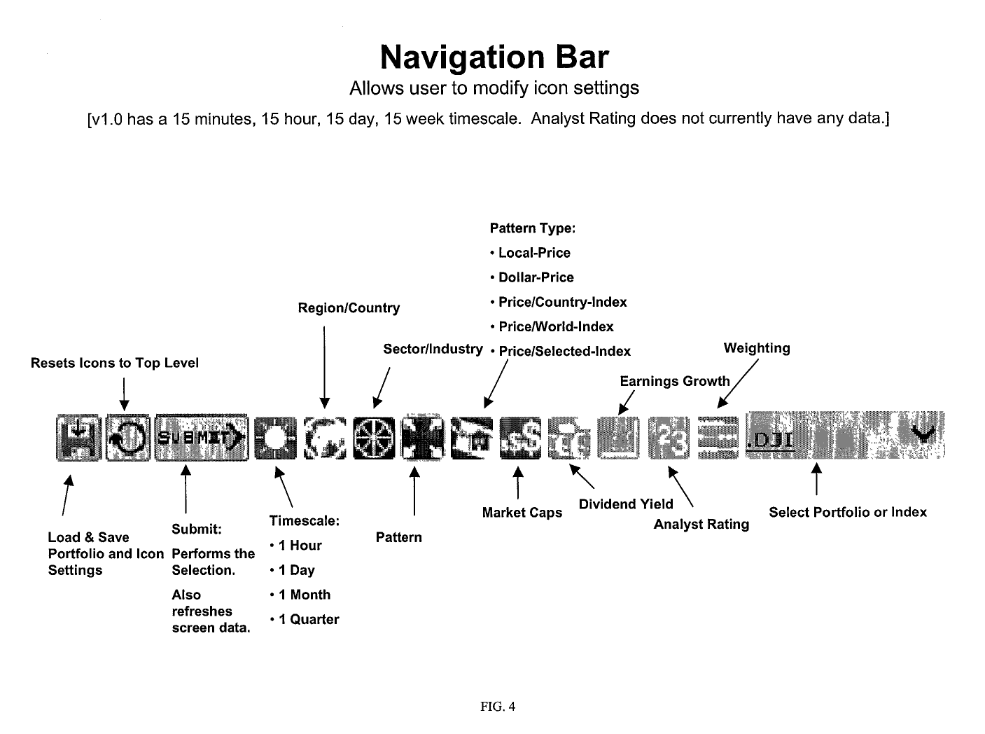

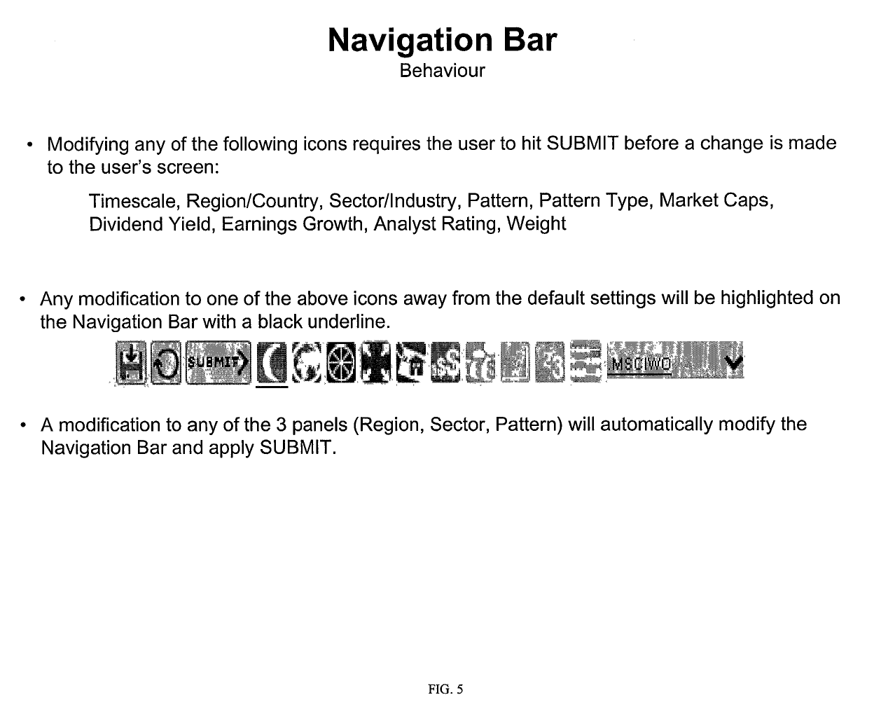

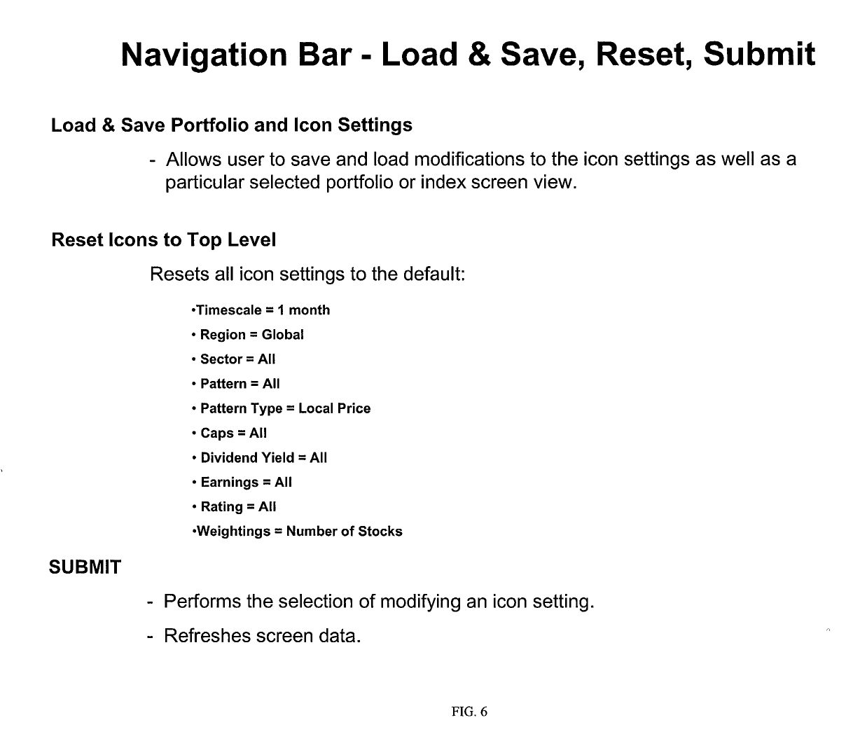

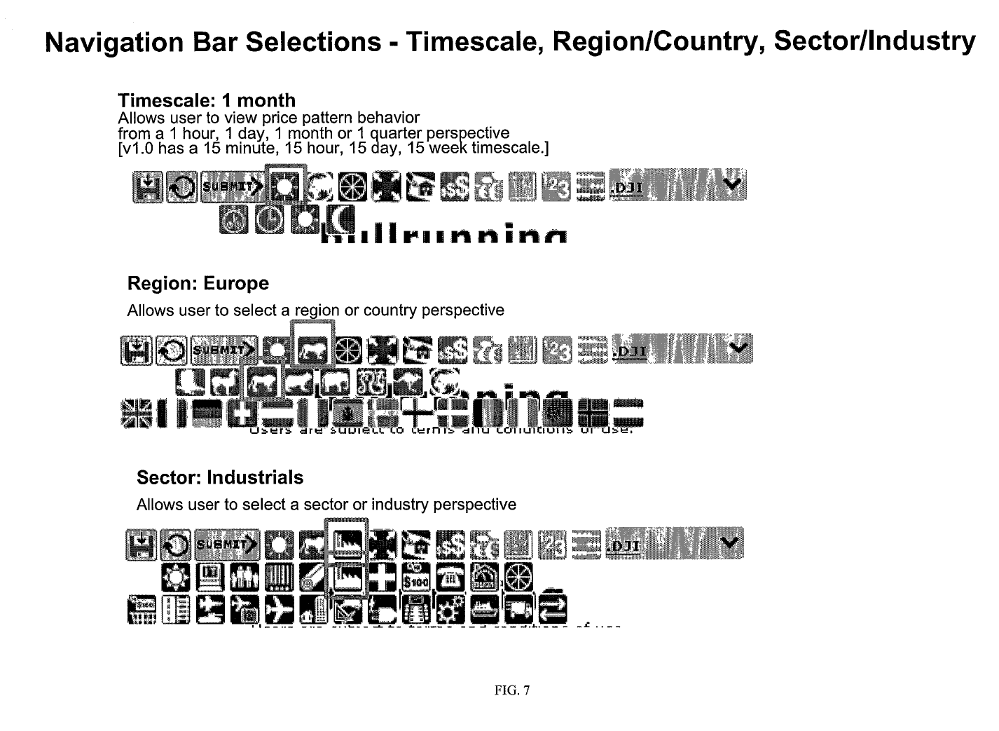

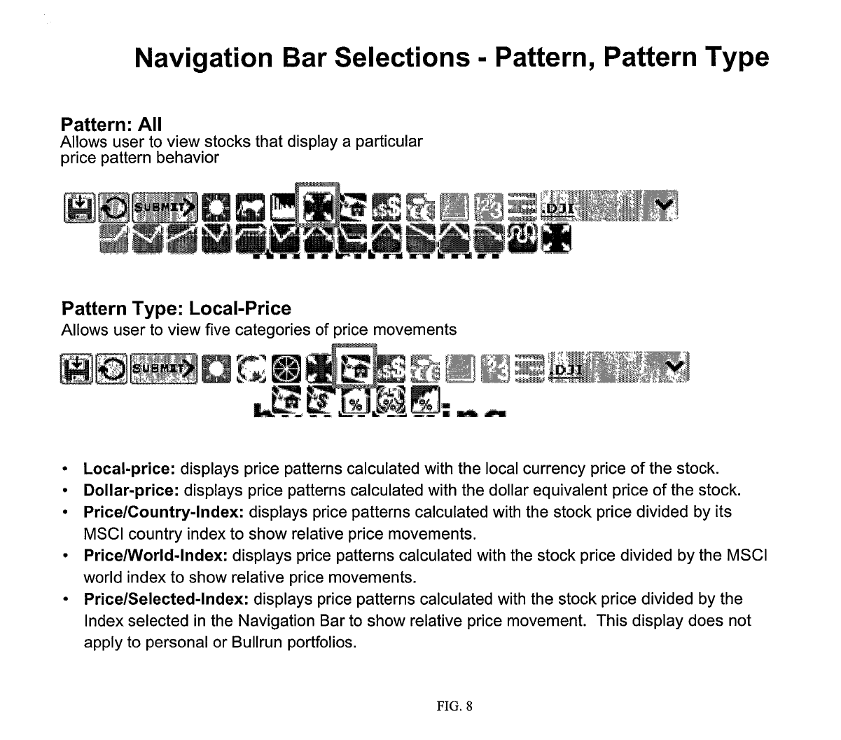

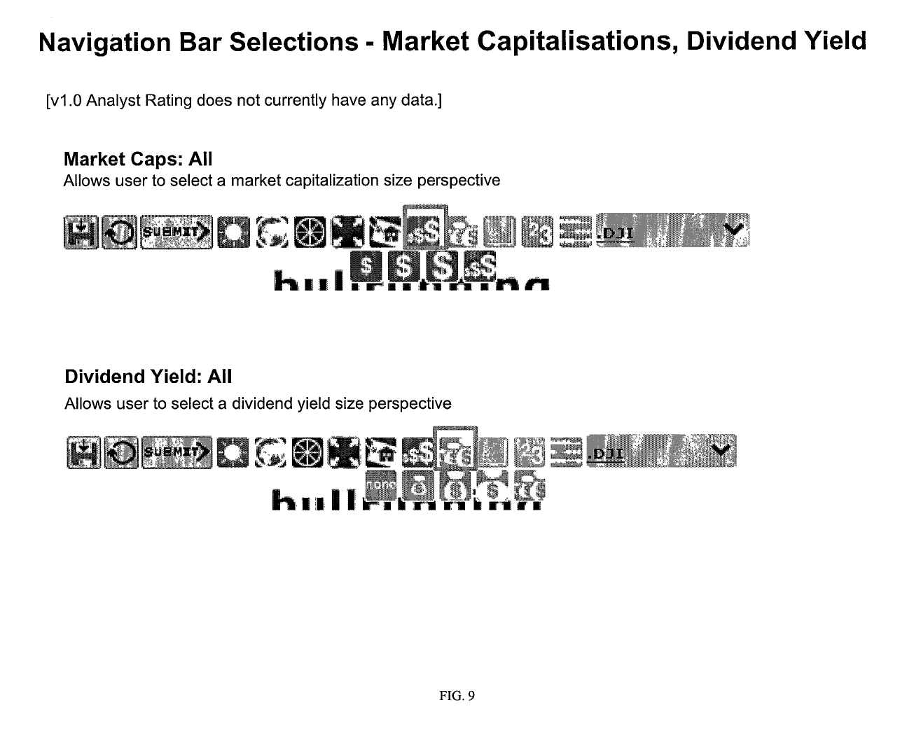

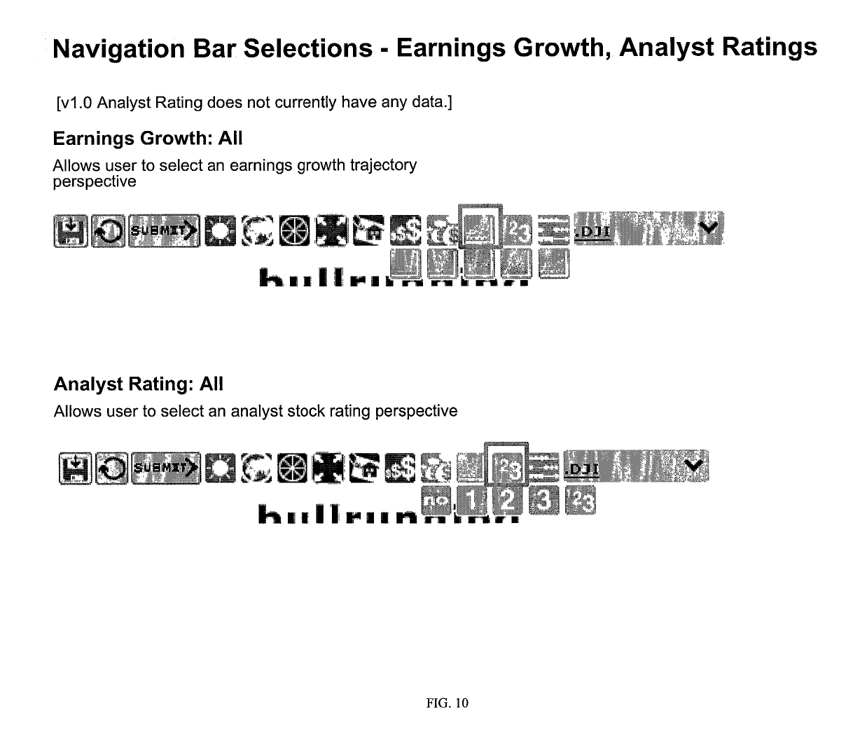

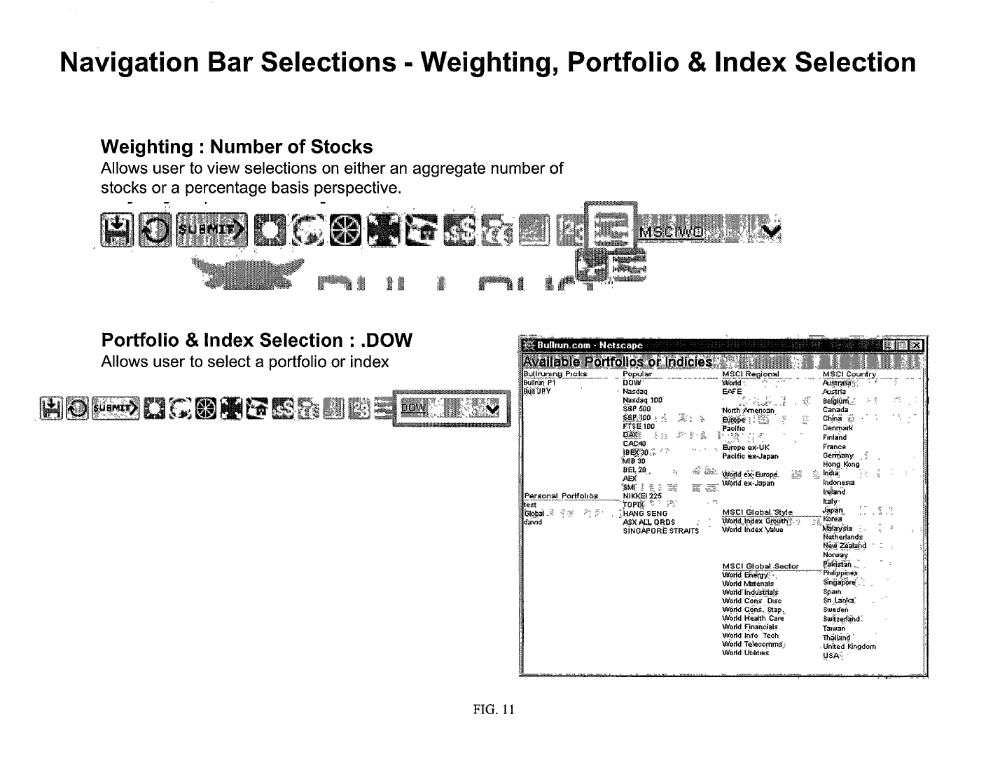

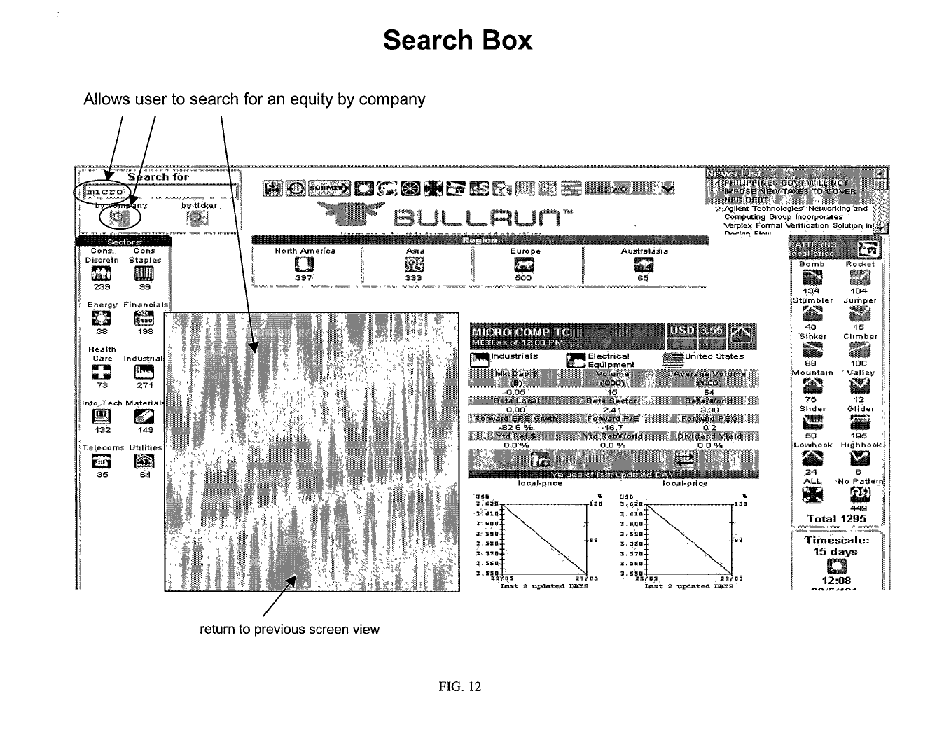

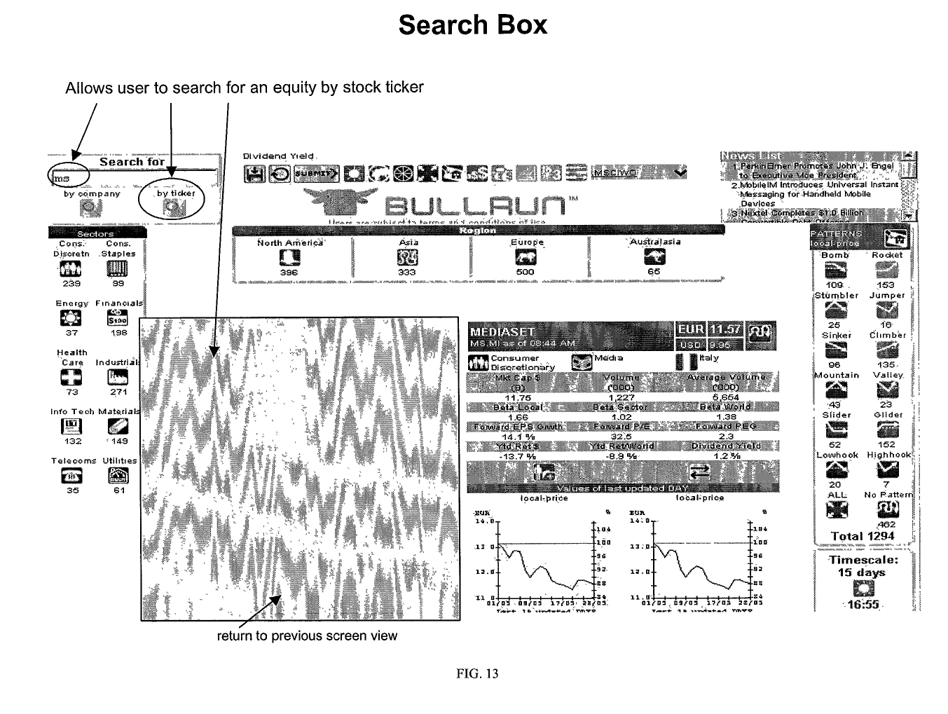

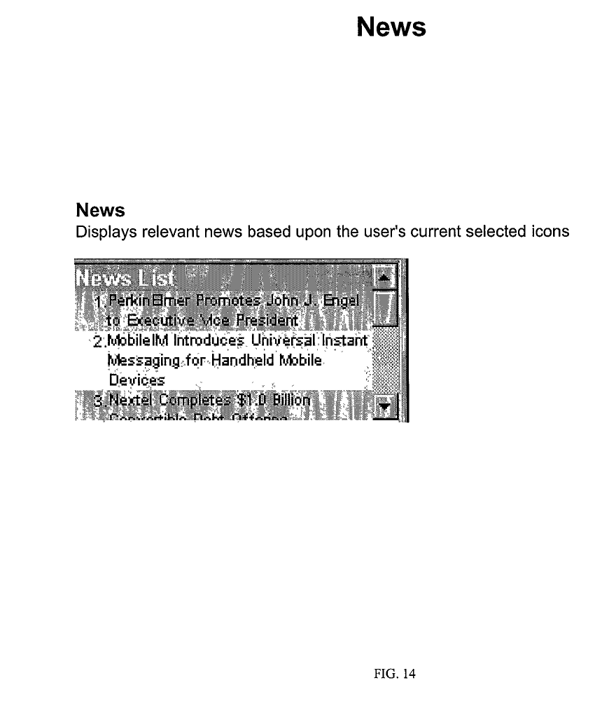

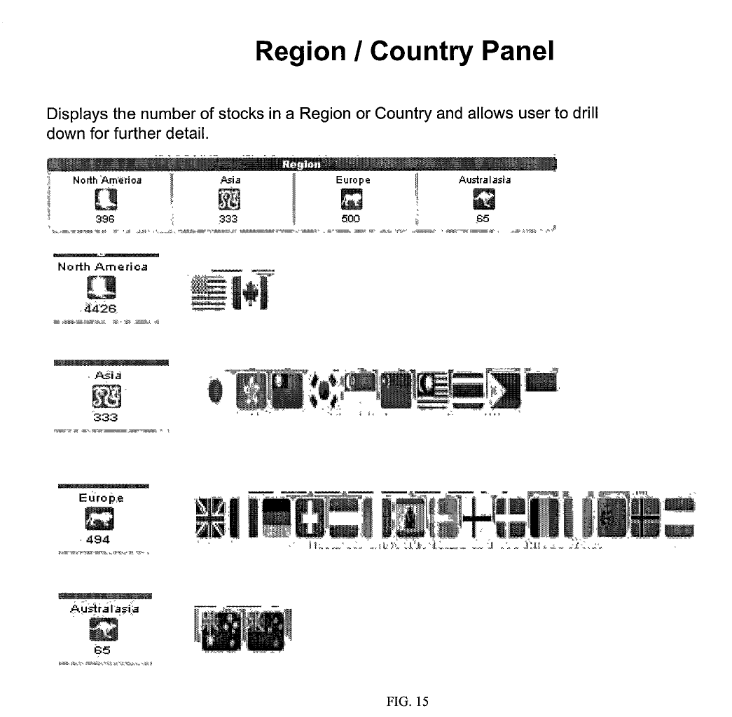

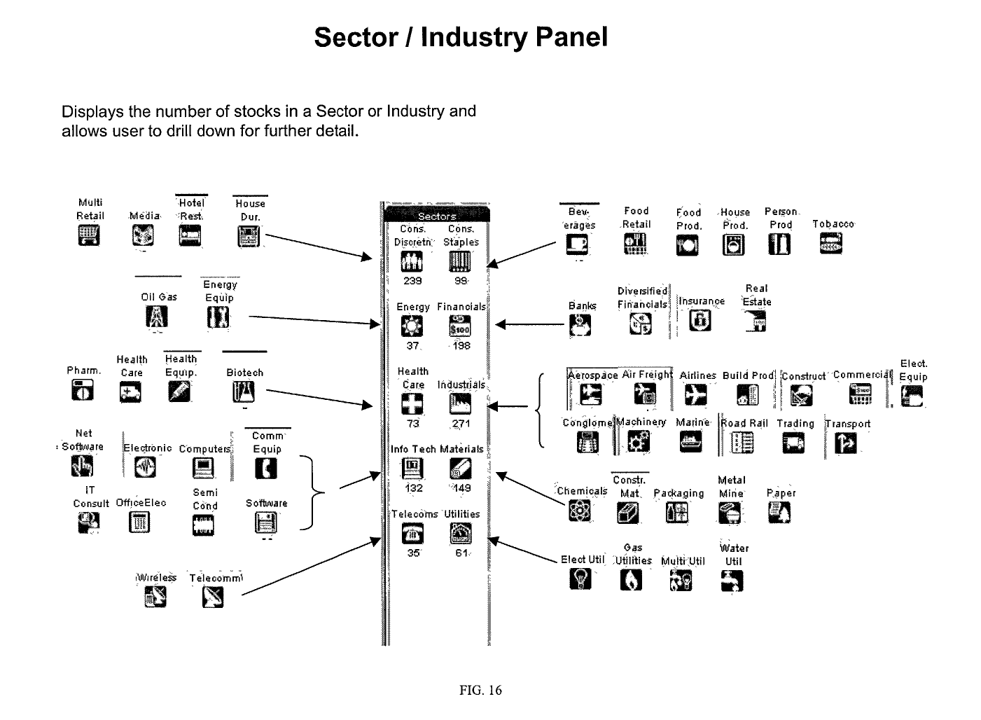

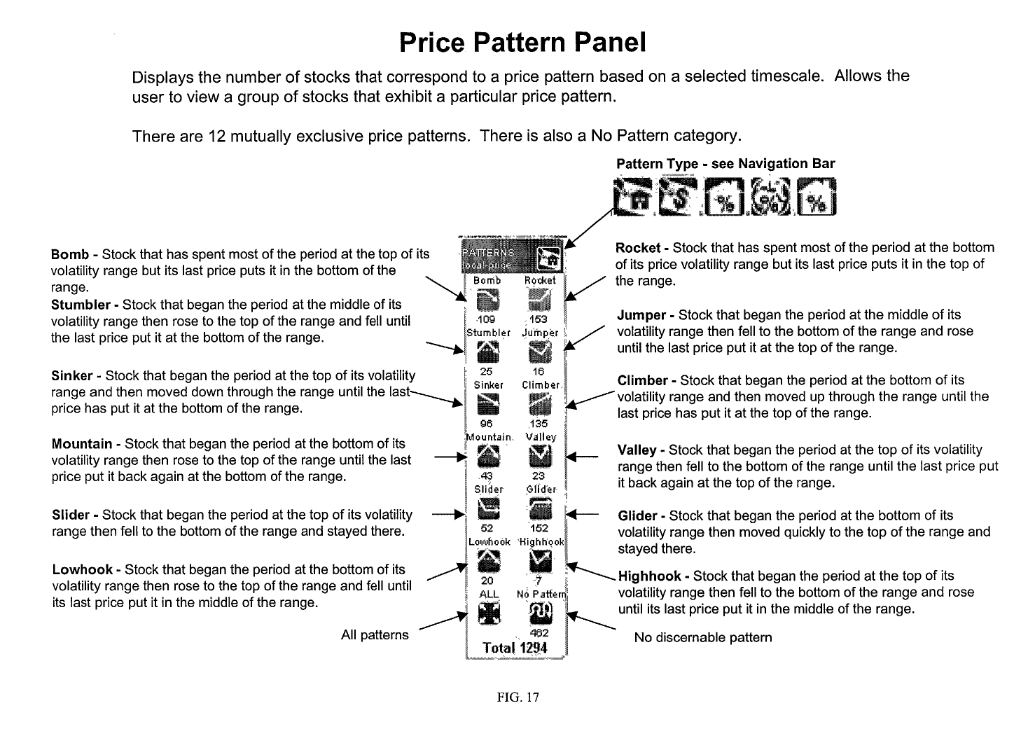

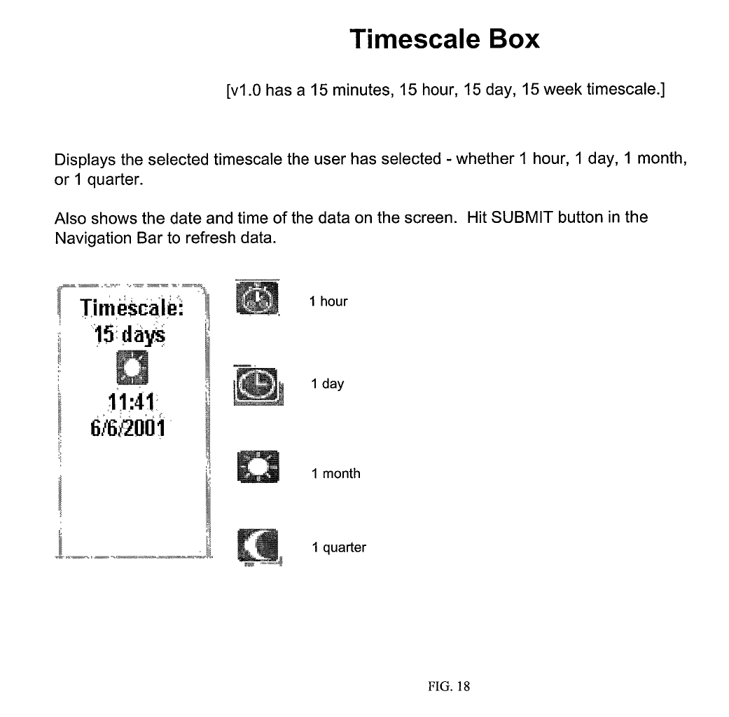

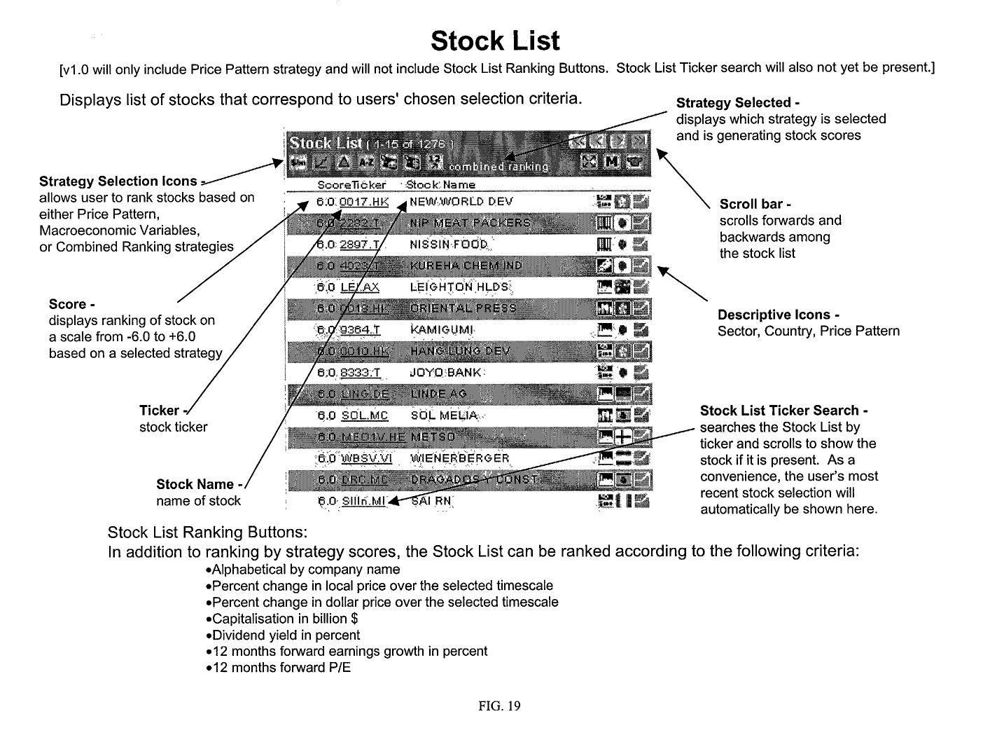

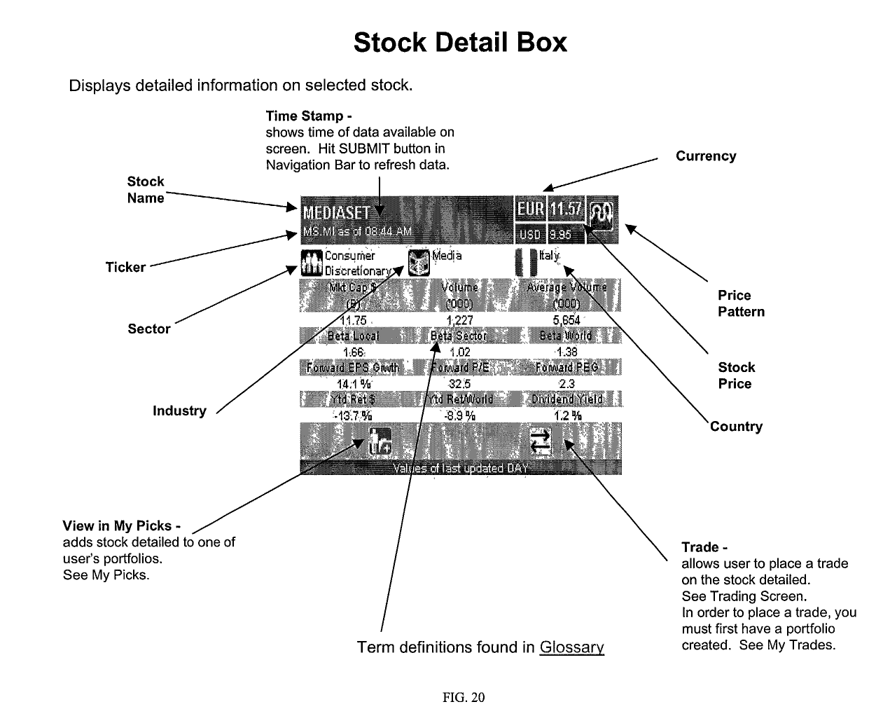

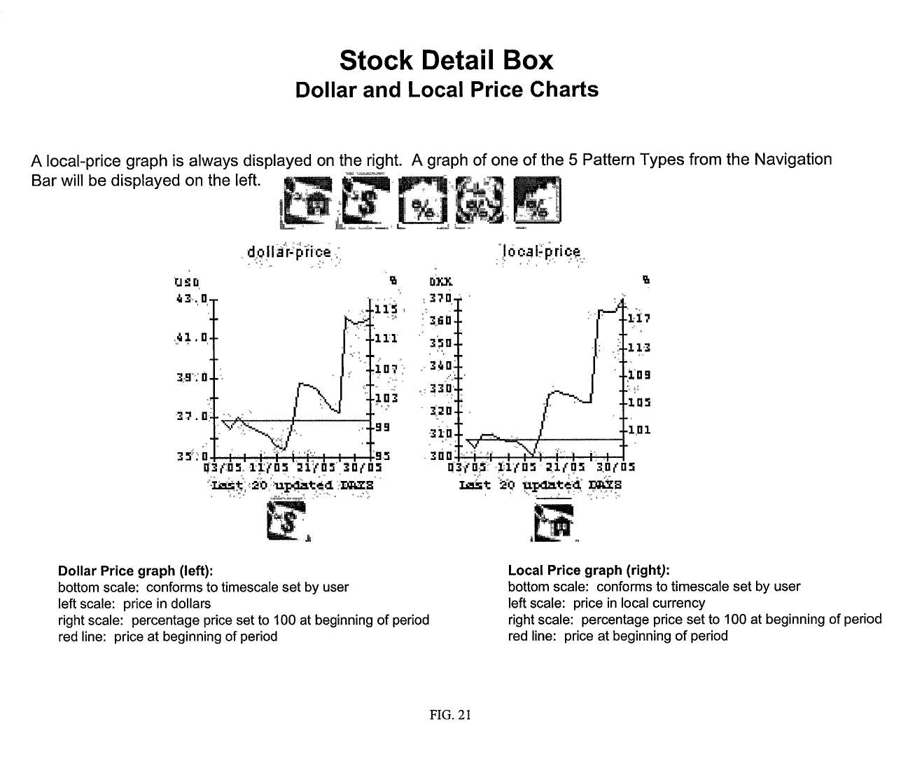

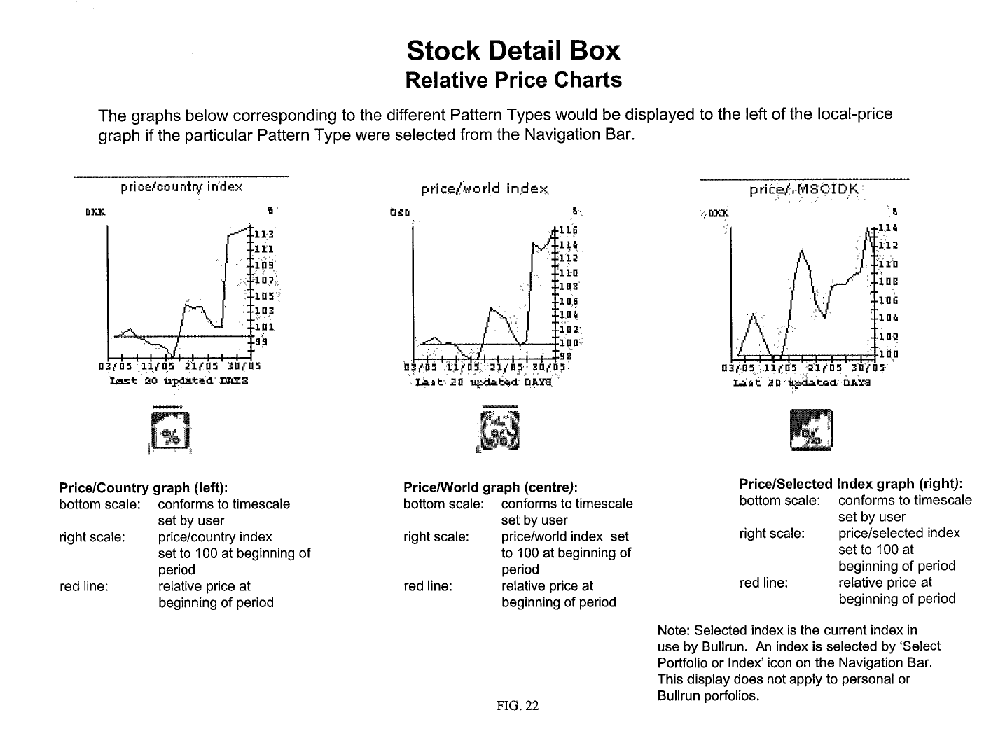

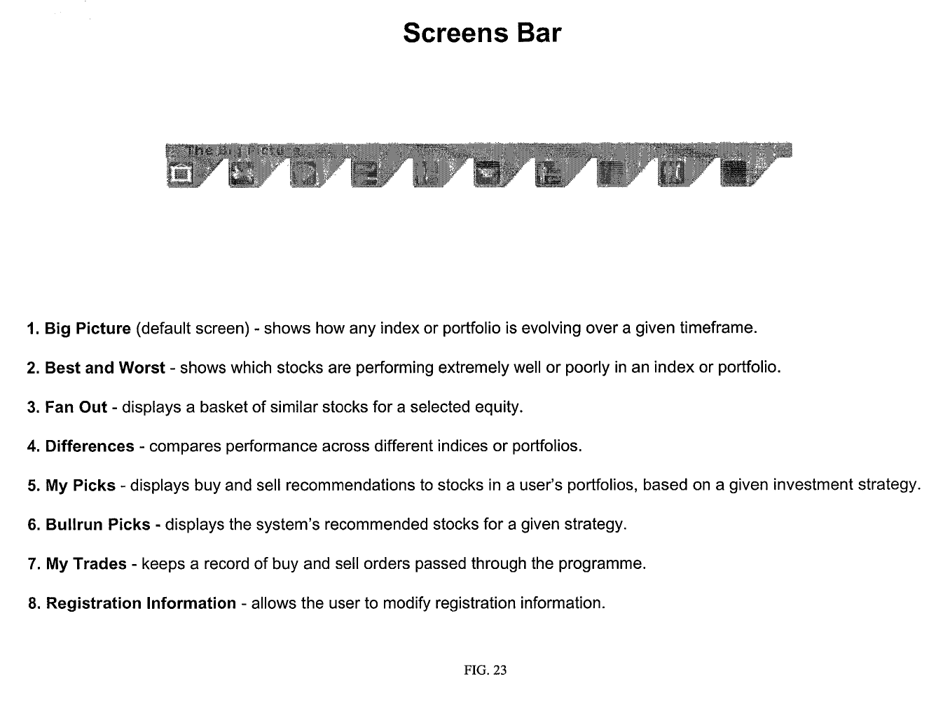

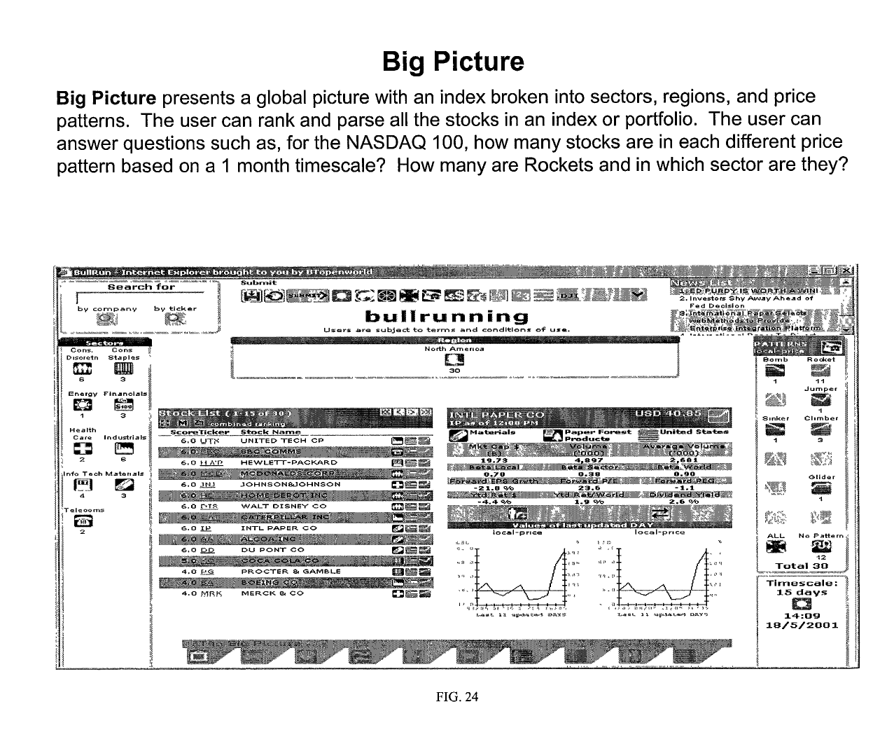

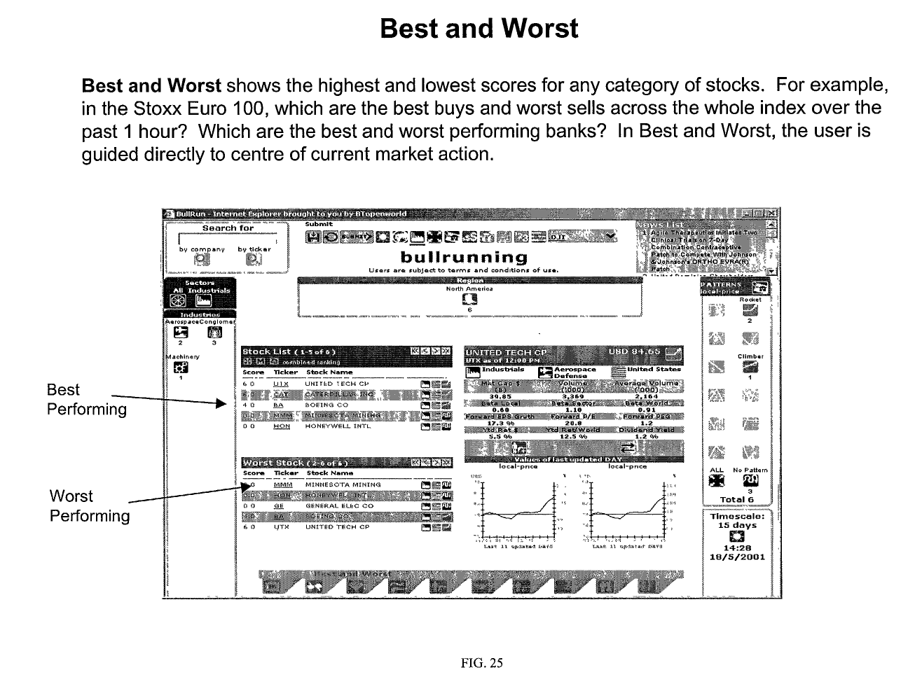

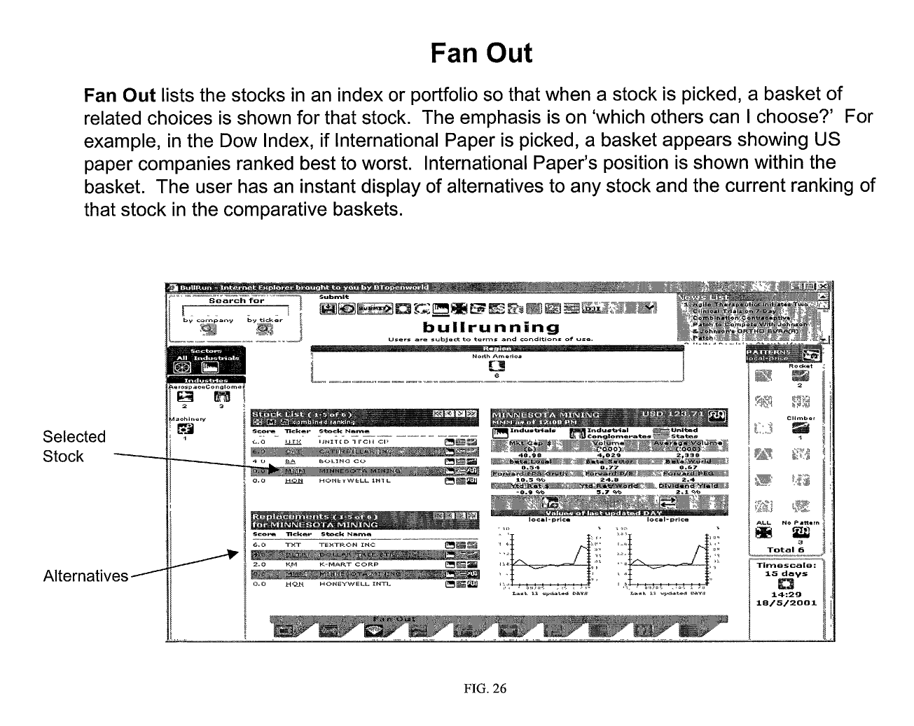

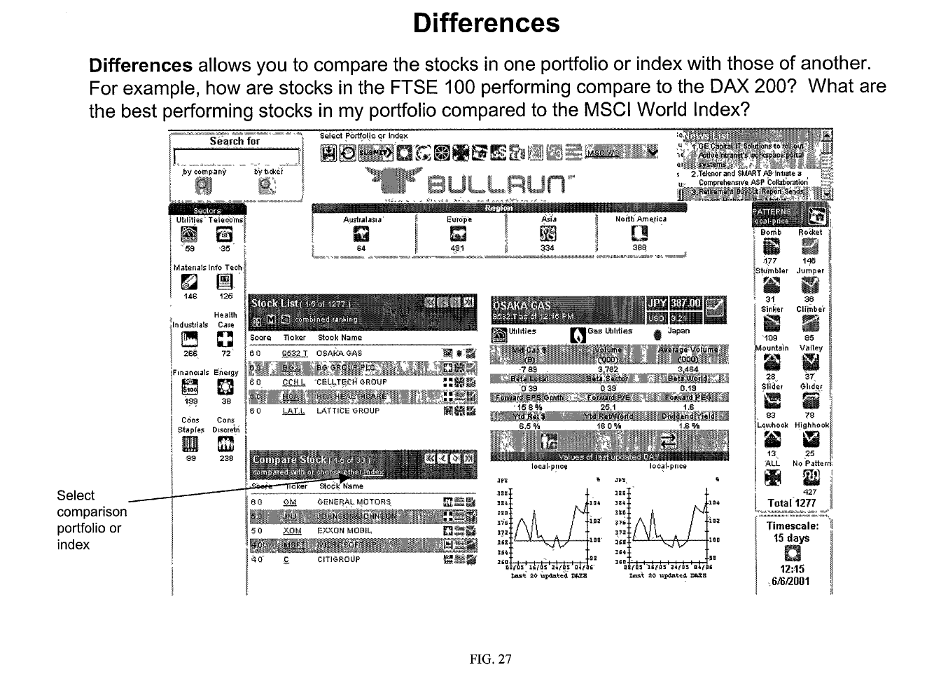

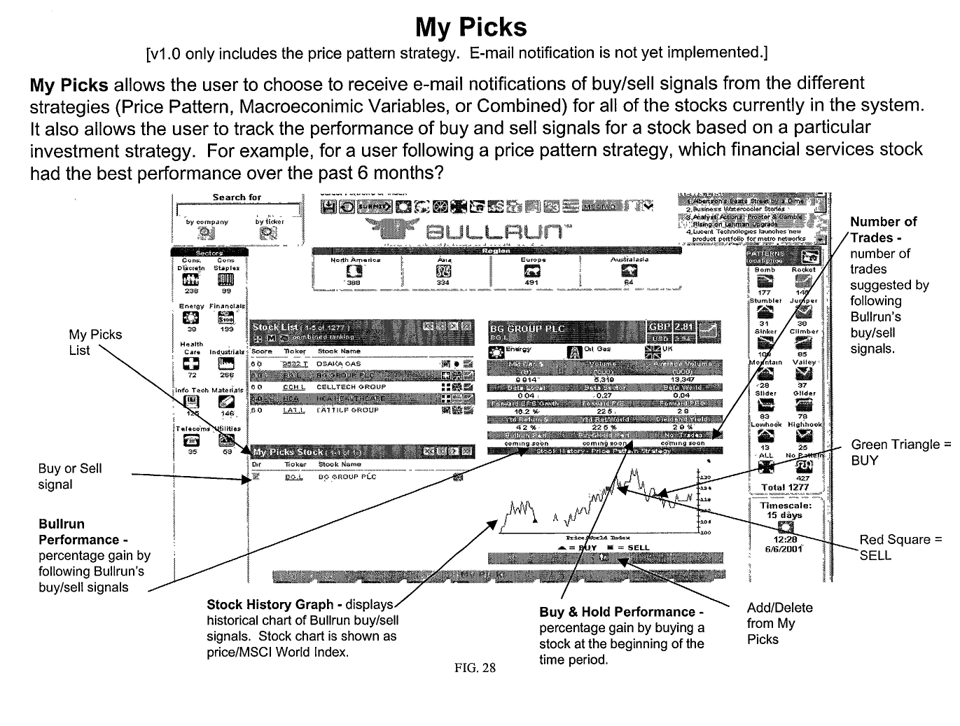

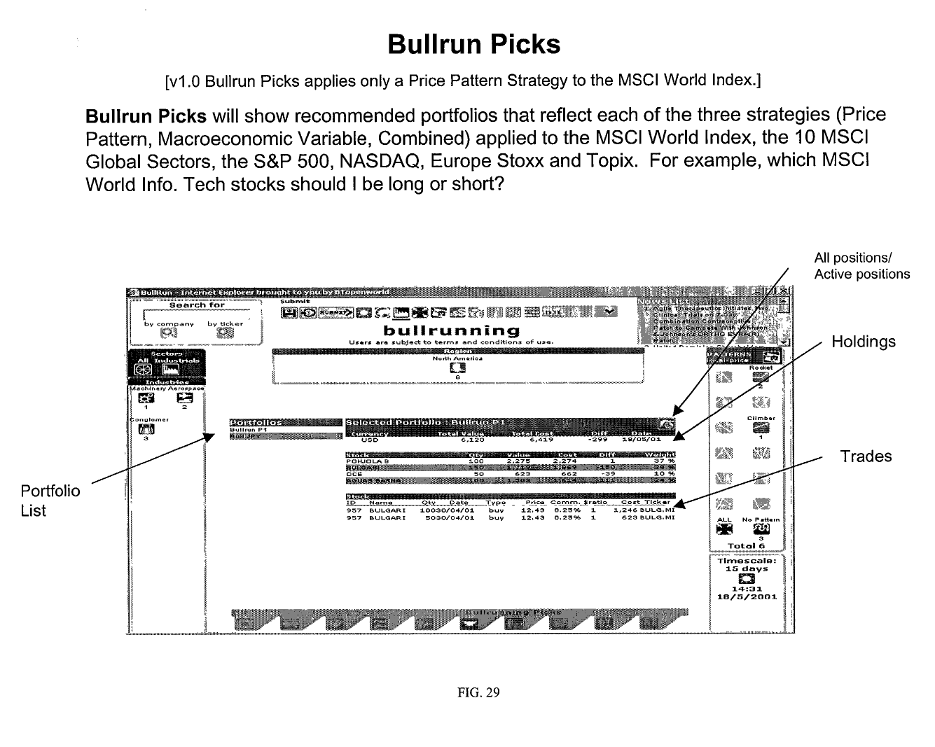

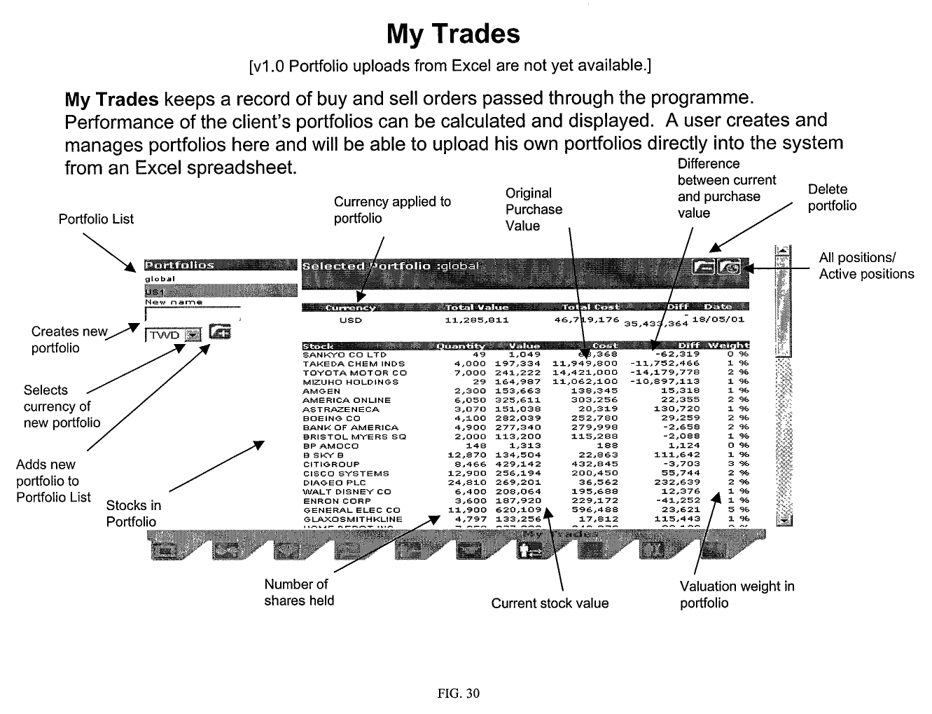

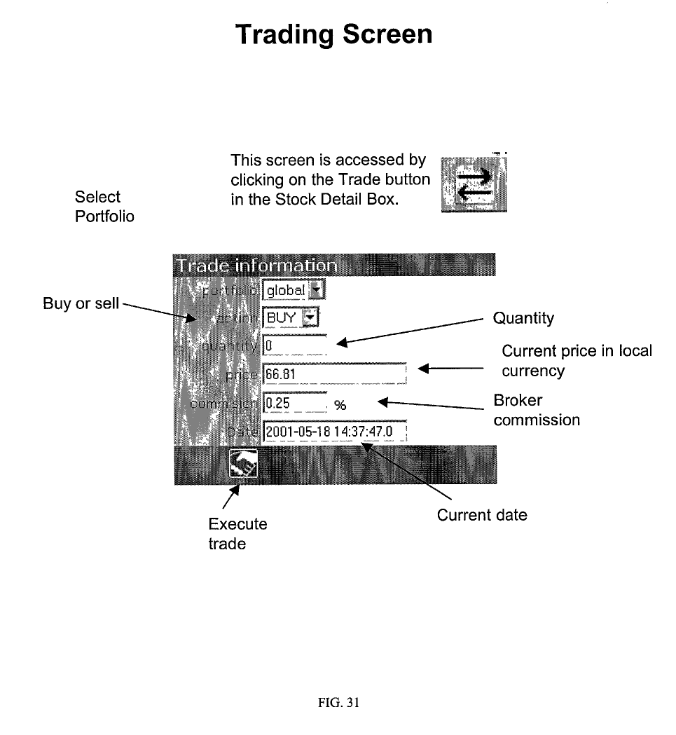

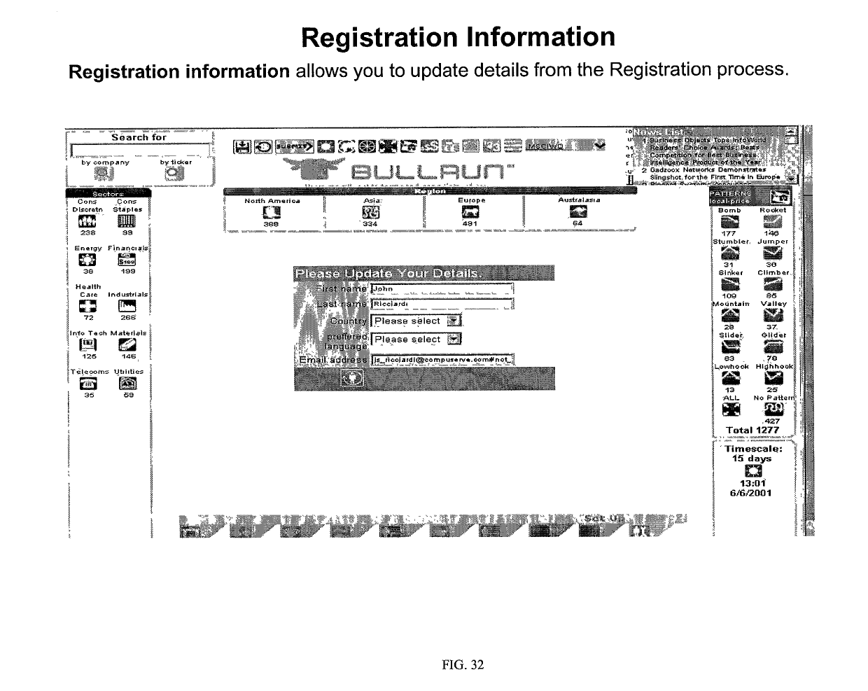

### DETAILED DESCRIPTION OF THE INVENTION AND PREFERRED EMBODIMENT

In the preferred embodiment, the system is comprised of a computer, which, as is well-known to those skilled in the art is comprised, among other things, of a processor, memory and mass storage. If the computer may also be networked to take advantage of other resources on a local or wide area network or the Internet. In addition, the computer can interface with an investment trader through a keyboard, mouse and display device. The computer may take the form of remote or wireless devices that can perform computations or receive investment signals from other computers or system practicing the present invention and the display device can take the form of a remote device, such as a personal digital assistant, pager or cell-phone with a visual, audio or tactile capabilities to communicate the investment signals. The computer executes the steps described herein to practice the present invention and a display device, which may be separate from the computer, presents the results to the investment trader.

Alternative embodiments of the present invention may also include transmitters to send information to the investment trader to request information and receivers to receive information back from the investment trader in accordance with the present invention.

Overall Steps

The following steps describe one aspect of practicing the present invention:

Step 1

Define sets of rules, called strategies, that can be coded to produce from published information, a sequence of buy and sell signals for every security in a given universe. Further define a set of time-scales for investment horizons to which the rules for each strategy can be adapted in order to produce buy and sell signals for every security in a given universe over those time-scales.

Step 2

Define a method of scoring the strategy's usefulness, for a time-scale, as applied to every security in a given investment universe, as well as scoring the aggregate usefulness of the strategy over all the securities in the given investment universe. Further define a method of presenting that information for each security, and of comparing that information among the securities in the given investment universe.

Step 3

Define a method of scoring every security in the given universe according to the buy and sell signals given by the strategy for a time-scale, in conjunction with published information such as the security's price behavior. Further define a method of presenting that information for each security, and of comparing that information among the securities in the given investment universe.

Step 4

Define a method for constructing portfolios of securities in a given universe, based on the scores generated for the securities, in conjunction with published information such as the security's market capitalization. Further define a methodology for constructing the portfolios with reference to the similarity of the constructed portfolios to other portfolios such as market indices.

Step 5

Define a method for combining portfolios derived from different strategies into a single portfolio. Further define a methodology for presenting that information.

With these definitions in place, the system will generate the following:

1. For all securities in the system, scores for the usefulness of every strategy over every time-scale, as well as the aggregate scores for these categories.

2. For all securities in the system, scores for securities according to every strategy over every time-scale.

3. For every market index in the system, portfolios ranging from similar to dissimilar for every strategy over every time-scale.

4. For every market index in the system, portfolios ranging from similar to dissimilar for combined strategies over every time-scale.

With these definitions in place, users can proceed as follows:

1. Select a universe of securities.

2. Select a strategy.

3. Select a time-scale.

4. Compare between securities the strategy's usefulness at that time-scale.

5. Compare between securities their scores given by the strategy.

6. Compare between securities their weights in the portfolios given by the strategy.

7. Compare between securities their weights in combined strategy portfolios.

8. Obtain the details of trades that would make the security holdings in a user's portfolio the same as those in a portfolio given by a strategy.

Defining Strategies, Setting Time-scales, Measuring Performance Results

1. Steps used for all strategies will now be described in more detail:

i. The steps for applying an investment strategy to a universe of securities will generate buy and sell signals for every security in the universe are as follows:

a. Buy and Sell Signals

A buy signal is a signal to purchase the security. A buy signal remains in effect until it is reversed by a sell signal, so that as far as the strategy is concerned, a security with a buy signal is bought and held until the strategy steps emits a sell signal for the security. A sell signal is a signal to sell the security. A sell signal remains in effect until it is reversed by a buy signal, so that as far as the strategy is concerned, a security with a sell signal is sold and not held until the steps emits a buy signal for the security.

b. Frequency of Updates to the Buy and Sell Signals

The steps for a strategy can update buy and sell signals at any frequency. For instance, the steps for a strategy can be run to update the latest buy and sell signals for each security in the universe per minute, per hour, per day, per week and so on.

c. Time-scales for the Buy and Sell Signals

1) Investment horizons vary according to individual investors. In order to provide buy and sell signals for groups of investors with shorter and longer investment horizons, the steps for a strategy generate separate sets of buy and sell signals for the securities in the universe according to shorter or longer time-scales.

i) Setting the time-scales.

a) A statistically meaningful sample size is needed to evaluate the performance of a strategy's buy and sell signals according to the confidence interval for results that is required. Sample sizes less than 15 give confidence intervals that would be too large for many investors. This gives minimum time-scales of 15 minutes for minutely signals, 15 hours for hourly signals, 15 days for daily signals, and 15 weeks for weekly signals, and so on.

b) Because groups of investors will want to chose among the time-scales that match their investment horizons, time-scales can be extended to cover common time measurements. For example, 60 minutes for minutely signals. 24 hours for hourly signals, 21 business days (about one month) for daily signals, and so on.

c) The data measurements input for a strategy are adjusted to provide a sets of buy and sell signals for securities in the universe for each time-scale. The set of buy and sell signals that the strategy generates for each security in the universe by using data measurements designed to give signals for a minutely time-scale is called the set of minutely signals for the strategy. The set of buy and sell signals that the strategy generates for each security in the universe by using data measurements designed to give signals for a weekly time-scale is called the set of weekly signals for the strategy, and so on.

d) Because the data measurements used by the strategy are not the same for each time-scale, the sets of buy and sell signals generated by the strategy for shorter and longer time-scales are likely to differ.

2) Adapting the data measurements used by the strategy to shorten and lengthen the investment horizons for the buy and sell signals.

i) Fractal strategy. A strategy that can be adapted to shorter and longer investment horizons by changing in some proportion the interval over which the data is measured can be called a fractal strategy. For a fractal strategy, the steps are applied to shorter and longer time-scales use data measurements taken over shorter and longer time-scales. The implication is that the strategy applies to the securities in the universe in a similar way over shorter and longer time-scales, that is to say at greater and lesser levels of detail. For example, a strategy can generate buy and sell signals for the universe of securities by taking as inputs for each security its price-pattern and its percentage price change. The steps for generating minutely buy and sell signals will use price-patterns and percentage price changes are calculated over 15 minutes. The steps for generating weekly buy and sell signals will use price-patterns and percentage price changes are calculated over 15 weeks, and so on.

ii) Non-fractal strategy. A strategy that uses different weightings of data sets for generating buy and sell signals for shorter and longer time-scales is non-fractal. For instance, to generate shorter time-scale signals the strategy can take a high weighting of expectations data, and to generate longer time-scale signals the strategy can take a high weighting of reported results. A non-fractal strategy takes different weightings of separate data inputs to generate signals for shorter and longer time-scales. For instance, the steps for a strategy can generate buy and sell signals for securitys by measuring changes in expectations for treasury yields, and by measuring the actual changes in treasury yields. (The expected changes for treasury yields can be calculated in real time from the forward markets.) The steps for generating minutely buy and sell signals will use a full weighting of the expected changes and a null weighting of the actual changes. The steps for generating weekly buy and sell signals will use a null weighting of the expected changes and a full weighting of the actual changes. Intermediate time-scales will use partial weightings of both expectations and actual changes.

d. Sampling Intervals to Create Histories of Buy and Sell Signals Over a Period

1) For a given time-scale, the strategy generates buy and sell signals for each security in the universe. Histories of buy and sell signals are created by recording the signals at intervals over a period. The sampling intervals vary according to the time-scale for which the signals are generated. For example:

a) Minutely. A set of minutely signals for securities in the universe is created by sampling the signals once per minute while the market is open. If done for 120 minutes, this will create a history of minutely buy and sell signals for the period with 120 data points for each security.

b) Hourly. A set of hourly signals is created by sampling the signals at the end of each hour that the market is open. If done for 120 hours, this will create a history of hourly buy and sell signals for the period with 120 data points for each security.

c) Daily. A set of daily signals is created by sampling the signals at the daily market close. If done for 120 days, this will create a history of daily buy and sell signals for the period with 120 data points for each security.

d) Weekly. A set of weekly signals is created by sampling the signals at the weekly market close. If done for 120 weeks, this will create a history of weekly buy and sell signals for the period with 120 data points for each security.

2) The interval at which signals for a time-scale are sampled in order to create histories of signals can be much longer than the frequency at which the signals are updated. For instance, although signals calculated for a daily time-scale can be updated each minute, it can be that only the signal at the daily close is taken into account for the history of the daily buy and sell signals.

3) The steps can be applied to historical data sets to generate histories of buy and sell signals as they would have appeared in the past. In this way, buy and sell signal histories of any length for any time-scale can be generated, covering any period for which there is data.

ii. Measuring the Performance Results. These steps will generate for every security in the universe the performance statistics that result from investing over a period according to the strategy's buy and sell signals at a given time-scale.

a. Periods

The periods over which the performance is calculated for the strategy's buy and sell signals correspond to the time-scale of the signals. The histories of buy and sell signals for the period will contain a number of data points that is statistically meaningful according to the confidence interval for results that is required. For example, choosing a sample size of 120 data points would measure performances over periods of 2 hours for minutely signals, 15 eight-hour days for hourly signals, 24 weeks for daily signals, and more than two years for weekly signals.

b. Trading Costs

Performance statistics for the strategy are adjusted for trading costs per signal. Average trading costs across markets, or average trading costs within markets are used to reflect trading costs in performance results for the strategy. For example, a cost of 1% per buy and sell signal can be used.

c. Benchmarks

In order to obtain a comparative measure for the outcome of having followed a strategy's buy and sell signals for a security, the present invention will compare the performance over the period from following the signals to a benchmark performance for the security over the period.

1) Absolute Benchmarks

i) Absolute Return Benchmark. In this case, the strategy's performance for the security is measured against a benchmark performance of 0% for the security. If the strategy generates a positive return over the period it will show a positive performance compared to benchmark. If the strategy generates a negative return over the period it will show a negative performance compared to benchmark. Comparing the strategy's performance to this benchmark will tell the user whether the strategy made money in the security, whatever the performance of the security over the period.

ii) Buy and Hold Return Benchmark. In this case, the strategy's performance is measured against the return from holding the security throughout the period. If the strategy generates a higher return by trading the security during the period than was had by holding the security during the period, it will show a positive performance compared to benchmark. Otherwise the strategy will show a negative performance compared to benchmark. Comparing the strategy's performance to this benchmark will tell the user whether the strategy made a higher return by not purchasing or trading the security than by holding the security over the period.

2) Relative Benchmarks

i) Market Return Benchmark. In this case, the strategy's performance for the security is measured against a market index return over the period. If the strategy generates a higher return by trading the security during the period than was had by holding the market index during the period, it will show a positive performance compared to benchmark. Otherwise the strategy will show a negative performance compared to benchmark. Comparing the strategy's performance to this benchmark will tell the user whether the strategy made a higher return by trading the security than by holding the market index over the period.

ii) Buy and Hold Relative Return Benchmark. In this case, the strategy's performance is measured against the security's return relative to the market index from holding the security throughout the period. If the strategy generates a higher return relative to the market index by trading the security during the period than was had by holding the security during the period, it will show a positive performance compared to benchmark. Otherwise the strategy will show a negative performance compared to benchmark. Comparing the strategy's performance to this benchmark will tell the user whether the strategy made a higher return relative to the market by trading in and out of the security than by holding the security over the period.

a) The calculations for this benchmark are identical to those for the Buy and Hold Return benchmark except that the security's price history over the period is divided by the market index's price history over the period.

b) The market index can be any index—a global, regional or country index, a sector or industry index, a large capitalization or small capitalization index, etc.

d. Security Performance Histories

1) Corporate actions. All performance histories for securities are adjusted by corporate actions. These include security splits and any other corporate actions that change the reported price of a security without changing the market value of the security, for instance by adjusting the number of shares outstanding.

2) Price Change Returns and Total returns. Performance histories for securities can contain price changes only. Alternatively, total returns including dividend payments can be used in the calculations of performance. For consistency, one of the two methods is applied throughout a single set of calculations for a security universe.

3) Local Currency Returns and Hedged Returns. Performance histories for securities can be expressed in the local currency for the security. Performance histories for securities can be expressed as local currency returns hedged into a reference currency by adjusting local currency returns for the costs of hedging into the reference currency.

4) Reference Currency Returns. Performance histories for securities can be expressed in a reference currency. Such performance histories are unhedged returns expressed in the reference currency. A simple method to create such a history is to divide the security's price history in local currency by the local currency's exchange rate with the reference currency.

iii. Calculating the Performance for the Buy and Sell Signals for a Security

These steps calculate the performance from following buy and sell signals for a security.

1) Signals=the history of buy and sell signals for the security over the period.

2) Positions=the history of recommended positions over the period.

a) Use the buy and sell signals in Signals to create a history of recommended positions in the security over the period.

b) A buy signal for the security sets the recommended position to ‘own’ for the subsequent data point and remains in effect until a sell signal sets the position to ‘do not own.’ The sell signal remains in effect until it is reversed by an eventual buy signal and so on.

3) Security Percent Changes=the percent change from one data point to the next in the security price over the period.

a) The security price will be one of the prices mentioned above, in local currency, hedged, in reference currency, in total return etc.

4) Alternative Percent Changes=the percent change from one data point to the next in the alternative investment's price over the period. The alternative investment is the investment vehicle owned by the strategy when the security is not owned.

a) The alternative investment will depend upon which of the benchmarks mentioned above is used.

i) For Absolute return and Buy and Hold Return benchmarks, Alternative Percent Changes is set to zero, or to a risk-free cash return from one data point to the next over the period.

j) For Market Index Return or Buy and Hold Relative Return benchmarks, Alternative Percent Changes is set to the percent change in the market index from one data point to the next over the period.

5) Strategy Performance=the return over the period from having the recommended positions, adjusted for trading costs.

a) Beginning at the start of the period, use the Security Percent Changes and the Positions to calculate the return over the period from ‘owning’ or ‘not owning’ the stock according to the Positions. When the Positions ‘own’ the security, assign the Security Percent Changes to the Strategy Performance. When the Positions ‘do not own’ the security, assign the Alternative Percent Changes to the Strategy performance.

b) Use the Signals to reduce the Strategy Performance by the trading cost at each switch from ‘own’ to ‘do not own’ and vice-versa.

6) Buy&Hold Performance=the return over the period from holding the security.

a) Beginning at the start of the period, use the Security Percent Changes to calculate the return over the period from holding the security.

7) Market Index Performance=the return over the period from holding the market index.

8) Number of Trades=the number of buy and sell signals in Signals.

9) Strategy-Benchmark=Strategy Performance-Benchmark Performance.

a) Absolute Return Benchmark. For this benchmark Strategy-Benchmark=Strategy Performance−zero.

b) Buy & Hold Return Benchmark. For this benchmark Strategy-Benchmark=Strategy Performance−Buy & Hold Performance.

c) Market Return Benchmark. For this benchmark Strategy-Benchmark=Strategy Performance−Market Index Return Performance.

d) Buy & Hold Relative Return Benchmark. For this benchmark Strategy-Benchmark=Strategy Performance−Buy & Hold Performance-Market Return Performance.

10) The following example shows how the Strategy Performance-Benchmark can be calculated for 131 data points using vectors. The benchmark is Buy & Hold Relative Return using the World Index as the market index. Trading cost is 0.5% per signal.

a) Vectors:

position=history over 131 days (+1, −1). {shows when we held the stock}

signal=history over 131 days (+1, 0, −1). {shows when we traded}

heldbool=boolean vector (set to 1 if position=1, 0 if not).

tradebool=boolean vector (set to 1 if signal < >0, 0 if not).

bhoneday=history over 131 days of one day % changes in security price/world−index.

bhresults=(1+bhoneday) multiplied in series from t-131 to present. {gives the buy & hold results relative to the world index for the whole period}

bulloneday=(heldbool*bhoneday)−(tradebool*0.005) {gives the strategy the one day performance of the buy & hold relative to the world index for each day the strategy held the security, and subtracts trading costs}

bullresults=(1+bulloneday) multiplied in series from t-131 to present. {gives the strategy results for the whole period}

numberoftrades=sum tradebool. {gives the number of trades}

b) Strategy Performance−Benchmark equals the last figure in bullresults minus the last figure in bhresults.

iv. The performance statistics for all the securities in the universe are aggregated to give aggregate performance statistics for the strategy applied to the securities in the universe over the period. These performance statistics refer to the results for a strategy at a time-scale.

1) For the strategy at the time-scale, the following figures are produced:

a) The number of securities in the universe.

b) The number of securities in the universe adjusted for securities that were eliminated from the calculations because of insufficient price histories for those securities.

c) The number of securities for which the Strategy Performance−Benchmark was positive. The percentage of the adjusted universe these represent. The average Strategy Performance- Benchmark across these securities. The average number of trades across these securities.

d) The number of securities for which the Strategy Performance−Benchmark was neutral. The percentage of the adjusted universe these represent.

e) The number of securities for which the Strategy Performance−Benchmark was negative. The percentage of the adjusted universe these represent. The average Strategy Performance-Benchmark across these securities. The average number of trades across these securities.

2) By using the steps on historical data sets, aggregate performance statistics are generated for a number of periods. These statistics show how a strategy has performed at a time-scale for a universe of stocks over subsequent periods.

2. Steps for the Price-pattern Strategy

i. This is a fractal strategy. These steps are adapted to shorter and longer time-scales by shortening and lengthening proportionally the timeframes for the data measurements upon which the strategy is based. To generate this strategy's buy and sell signals for a security at a time-scale, proceed as follows:

a. PricePattern=the price pattern for the security at the time-scale. This is represented by an integer from +6 to +1 for the six positive price patterns, 0 for no pattern, and −1 to −6 for the six negative price patterns.

b. Security Price Change=percent change in the security's price over a number of data points proportional to the number of data points used to calculate the PricePattern. For example, for a PricePattern calculated over 15 data points, use the percent change calculated from 10 data points ago to the current data point.

c. Short Average Price Change=short-term average of Security Price Changes over a number of data points proportional to the number of data points used to calculate the PricePattern. For example, for a PricePattern calculated over 15 data points, use an average of the Security Price Changes for the past 30 data points.

d. Long Average Price Change=long-term average of Security Price Changes over a number of data points proportional to the number of data points used to calculate the PricePattern. For example, for a PricePattern calculated over 15 data points, use an average of the Security Price Changes for the past 60 data points.

e. Short Volatility=absolute value of the Short Average Price Change.

f. Long Volatility=absolute value of the Long Average Price Change.

g. Short−Long Volatility=Short Volatility−Long Volatility.

h. Position t-1=1 if the security was owned, or −1 if the security was not owned at the previous data point.

i. Signal t=1 for a buy signal, 0 for no signal, or −1 for a sell signal at current data point.

j. If Position t-1 is not defined, the steps has not been run for this security before. Initialize Position t-1 by setting (Position t-1=1) if the PricePattern is positive, or setting (Position t-1=−1) if the Price Pattern is not positive.

k. If Short-Long Volatility is positive, then apply the following Mean Reversion steps to generate a buy signal, no change, or a sell signal.

1) If the security was owned at the previous data point (Position t-1=1), check whether its PricePattem is very positive (PricePattern>3) and its price has risen substantially (Security Price Change>Short Volatility).

a) If so, generate a sell signal (set Signal t=1).

b) Otherwise generate no change (set Signal t=0).

2) If the security was not owned at the previous data point (Position t-1=−1), check whether its PricePattern is very negative (PricePattern<−3) and its price has fallen substantially (Security Price Change<−Short Volatility).

a) If so, generate a buy signal (set Signal t=1).

b) Otherwise generate no change (set Signal t=0).

1. If Security Volatility is negative, apply the following Momentum steps to generate a buy signal, no change, or a sell signal.

1) If the security was owned at the previous data point (Position t-1=1), check whether its PricePattern is negative (PricePattern<0).

a) If so, generate a sell signal (set Signal t=1).

b) Otherwise generate no change (set Signal t=0).

2) If the security was not owned at the previous data point (Position t-1=−1), check whether its PricePattern is positive (PricePattern>0).

a) If so, generate a buy signal (set Signal t=1).

b) Otherwise generate no change (set Signal t=0). m. An example of the PricePattern strategy steps is a follows:

1) Variables:

pp=stock's price pattern for price/world-index

D10=% change over 10 days of stock's price/world-index

D10M30=30 day moving average of D10

D10M60=60 day moving average of D10

Signal=+1,0,−1

Position=+1,−1

2) If D10M30>D10M60 THEN Mean Reversion ELSE Momentum

a) CASE Mean Reversion

IF position t-1=1 THEN {we own it}

IF (pp t>=4) AND (D10 t>ABS(D10M30 t)) THEN

Signal t=−1 {sell it}

Position t=−1

ELSE

Signal t=0 {don't sell it}

Position t=1

ELSE {position t-1=−1} {we don't own it}

IF (pp t≦=−4) AND (D10 t<−ABS(D10M30 t)) THEN

Signal t=+1 {buy it}

Position t=+1

ELSE

Signal t=0

Position t=−1 {don't buy it}

END {ELSE}

b) CASE Momentum

IF position t-1=1 THEN {we own it}

IF pp t<0 THEN

signal t=−1 {sell it}

position t=−1

ELSE {pp t>=0}

signal t=0 {don't sell it}

position t=1

ELSE {position=−1} {we don't own it}

IF pp t>0 THEN

signal t=+1 {buy it}

position t=+1

ELSE {pp t<=0}

signal t=0 {don't buy it}

position t=−1

END {ELSE}

ii. Time-scale Inputs. For Strategy signals at a 15 minute time-scale, use Price Patterns calculated over 15 minutely data points, and prices at minutely intervals. For Strategy signals at a 15 day time-scale, use Price Patterns calculated over 15 daily data points, and prices at daily intervals, and so on.

3. Steps for the Macroeconomic Strategy

i. Select Variables

A selection is made of macro variables (economic and financial) across the major developed countries and regions together with aggregations of these variables. Selected steps are applied to each variable to determine whether it is rising or falling.

ii. Assign a Hierarchy to Variables

The hierarchies cover regions, with the most important regions given the top ranking. The hierarchies also cover the variables belonging to economic domains within regions.

a ii. Eliminate Coincident Variables

Because some of the selected variables rise and fall at the same time, they give the same signals. Variables that are lower in a hierarchy and give the same signals as variables higher in the hierarchy are eliminated to avoid double-counting.

iv. Calculate Sensitivity of Target Indices to the Variables

The sensitivity coefficient is calculated as the average of the target index's subsequent performance when the macro variable has been rising, minus the average of the target index's subsequent performance when the macro variable has been falling. The sensitivity coefficient can be positive or negative. Calculate the sensitivity coefficient for each macro variable against each market index (5 regions, 10 sectors, and 58 industry groups), total 73 market indices.

v. Eliminate Unreliable Variables

The reliability of the sensitivity relationship is measured by calculating the probability that the variable's rise or fall gave the correct signal for the target index's subsequent month's performance. The higher the probability, the more reliable the variable's sensitivity coefficient.

vi. Matrix of Important Relationships

For each market index, the variables whose coefficient sensitivity is most significant, and is most reliable, are retained. Their coefficients are aggregated in a matrix, where the coefficients for every variable affecting each market index are assigned to that market index.

vii. Calculate the Maximum Scores

For each of the 73 market indices, calculate the maximum score (total coefficient sensitivity) that would be obtained if every macro variable affecting the market index favoured the index.

viii. Calculate the Current Score for Each Market Index

Calculate the current score by multiplying each variable's coefficients in the matrix by 1 if the variable is rising, and by −1 if the variable is falling. By summing the sign-adjusted coefficient of every variable affecting the market index, the current score for that market index is obtained.

ix. Calculate the Current Percentage Score for Each Market Index

Dividing the current score for each market index by its maximum score, and multiplying by 100 gives the current percentage score for the market index. These scores range between +100, most favourable for the market index, to −100, least favourable for the market index.

x. Correlate Individual Security Price Movements to Regional, Sector, and Industry Price Movements

Each security is classified by region, sector and industry. The price movements of each security in the investment universe are correlated with price movements of the security's region, sector, and industry indices. For each security, three correlation coefficients are obtained. The first is the correlation between the security's performance relative to the world index and the security's regional market index performance relative to the world index. The second is the correlation between the security's performance relative to the world index and the security's sector market index performance relative to the world index. The third is the correlation between the security's performance relative to the world index and the security's industry market index performance relative to the world index. The correlation coefficients range between +1 and −1. If negative correlation effects are not desired, correlation coefficients less than zero are set to zero.

xi. Calculating Individual Security Scores

As every stock will have three effects (Region, Sector, Industry), these are weighted and summed to give a current score for each security. The current percentage scores for the security's regional, sector and industry indices are weighted by the security's regional, sector and industry correlation coefficients. Summing the three weighted current percent scores and id dividing by three gives the security's current score. Security scores range between 100 and −100. In this way, macroeconomic variables affecting entire regions, sectors and industries are used to create a score for an individual security by taking into account the security's price correlation with its region, sector and industry. In practice, a score of 100 would be rare indeed as it would require that all variables favour the security's regional, sector, and industry indices, and that the correlation coefficients between the security and its three indices all be equal to 1.

xii. Further Weightings

The relative importance of regional, sector and industry effects can be further weighted to take into account general market index characteristics such as the number of stocks in the index. Further weightings can reflect the fact that few macro variables were found for strong ‘regional’ relationships and so our level of confidence is higher for the sector and industry readings and the weights should reflect this. Any such further weightings are applied when summing the security's regional, sector and industry percentage scores weighted by the security's correlation coefficients with those indices.

xiii. Generating Buy and Sell Signals from the Security Scores

a. Steps Using Security Scores

1) Security Score=current security score.

2) Position t-1=1 if the security was owned, or −1 if the security was not owned at the previous data point.

3) Signal t=1 for a buy signal, 0 for no signal, or −1 for a sell signal at current data point.

4) If Position t-1 is not defined, the steps have not been run for this security before. Initialize Position t-1 by setting (Position t-1=1) if the Security Score is positive, or setting (Position t-1=−1) if the Security Score is not positive.

5) If the security was owned at the previous data point (Position t-1=1), check whether its Security Score is negative (Security Score<0).

a) If so, generate a sell signal (set Signal t=1).

b) Otherwise generate no change (set Signal t=0).

6) If the security was not owned at the previous data point (Position t-1=−1), check whether its Security Score is positive (Security Score>0).

a) If so, generate a buy signal (set Signal t=1).

b) Otherwise generate no change (set Signal t=0).

b. Steps Using Security Scores and Changes in Security Scores

1) Security Score=current security score.

2) Score Change=change in the Security Score over a statistically meaningful number of data points. The number of data points can be chosen to be consistent with signals given by Price Patterns. For example, measure the change in the security score over 15 data points in order to be consistent with PricePatterns calculated over 15 data points.

3) Position t-1=1 if the security was owned, or −1 if the security was not owned at the previous data point.

4) Signal t=1 for a buy signal, 0 for no signal, or −1 for a sell signal at current data point.

5) If Position t-1 is not defined, the steps have not been run for this security before. Initialize Position t-1 by setting (Position t-1=1) if the Security Score is positive, or setting (Position t-1=−1) if the Security Score is not positive.

6) If the security was owned at the previous data point (Position t-1=1), check whether its Security Score is negative (Security Score<0) and its Score Change is negative (Score Change<0).

a) If so, generate a sell signal (set Signal t=1).

b) Otherwise generate no change (set Signal t=0).

7) If the security was not owned at the previous data point (Position t-1=−1), check whether its Security Score is positive (Security Score>0) and its Score Change is positive (Score Change>0).

a) If so, generate a buy signal (set Signal t=1).

b) Otherwise generate no change (set Signal t=0).

xiv. Time-scale Adjustments

Because the Macroeconomic Strategy is non-fractal, its steps are adapted to different time-scales by changing the weightings between expectations for macroeconomic variables and actual results for macroeconomic variables. The steps also take into account the first reports of changes in expectations and first reports of changes in the macroeconomic variables. The minutely time-scale has a full weighting for expectations and a null weighting for actual results. The weekly time-scale has a null weighting for expectations and a full weighting for actual results. This is shown in the programmed specification for the Macroeconomic Strategy.

A.

B. Macroeconomic Strategy Steps in Detail

The present invention's ‘Macro-based’ stock selection process can be divided into five distinct sections as outlined below. Section A details the universe of countries and economic/market variables as well as the selection method. Section B explains the various mathematical transformations that were applied to the underlying macro variables before they were tested for sensitivity with global market indices. Section C outlines the procedure for calculating the sensitivity and reliability for each macro variable's with each of the 73 selected relative indices (10 Sectors, 58 Industries, 5 Regions). Section D aggregates the surviving coefficients calculated in the previous step and adjusts for the underlying volatility of the various indices as well as weighting these results. Finally, Section E translates the readings calculated in Section D into actual buys and sells for individual stocks based on the macro readings for each of the sector, industry and regional indices and each index member's correlation with its respective index.

A. Macro Variable Selection Process

A selection of macro variables (economic and financial) across the major developed countries and regions together with aggregations of these variables was made.

The underlying macro variables selected in each country/region, where they existed, are outlined in Table 1 below. The variables were broken up into 10 broad categories.

TABLE 1
Classification of Macro Variables

| | |
|---|---|
| 1. Short-term Interest Rates | 8. Prices |
| a) Treasury Bills (3 month) | a) CPI Headline Index |
| 2. Long-term Interest Rates | b) CPI Core Index |
| a) Government Bond (10 year) | c) Government Deflator Index |
| b) Swaps (10 year) | d) Inflation Expectations |
| c) Corporates (10 year) | e) Wage Index |
| d) Inflation Indexed | f) Unit Labour Costs |
| 3. Yield Curves | g) Headline Producer Prices |
| a) Government Yield Curve | h) Core Producer Prices |
| (10 year-3 month) | i) Import Prices |
| b) Swap Yield Curve (10 year-3 month) | j) Housing Prices |
| 4. Yield Spreads | k) Commodity Price |
| a) Corporate-Government Spread | l) Oil Price |
| b) Swap Spread-Government Spread | m) Metals Price |
| 5. Money Supply | n) Gold Price |
| a) Narrow Money Supply | 9. Industrial Activity |
| b) Broad Money Supply | a) Industrial Production |
| c) Narrow Liquidity (Supply-Demand) | b) Production Surveys |
| d) Broad Liquidity (Supply-Demand) | c) Capacity Utilisation |
| e) Credit | d) Orders |
| f) Foreign Reserves | e) Construction Surveys |
| 6. Exchange Rates | f) Investment |
| a) Trade Weighted Exhange Rates | 10. Consumer Activity |
| b) Dollar Spot Exchange Rates | a) Consumer Confidence |
| c) Yen Spot Exchange Rates | b) Consumption |
| d) Euro Spot Exchange Rates | c) Employment |
| 7. External Accounts | d) Retail Sales |
| a) Exports | e) Retail Surveys |
| b) Trade Balance | f) Vehicle Registrations |
| c) Current Account | g) Real Wages |
| d) Trade Surveys | h) Housing Starts |
| | 11. Unemployment |
| | a) Unemployment rate |

Economic and financial market variables were taken from the regions and countries outlined in Table 2 below.

TABLE 2
Geographical Distribution of the Macro Variables

| | | | |
|---|---|---|---|
| Global * | Spain | Denmark | South Korea |
| Europe * | Portugal | Switzerland | Taiwan |
| Asia * | Austria | Norway | Thailand |
| United States | Belgium | United Kingdom | Malaysia |
| Canada | The Netherlands | China | Philippines |
| Germany | Finland | Japan | Indonesia |
| France | Ireland | Hong Kong | Australia |
| Italy | Sweden | Singapore | New Zealand |

* indicates an aggregation of underlying countries

B. Calculation of the State (Rising/Falling) of the Macro Variable and Eliminate Coincident Variables

1) Transformation Process

(a) Check that the length of the series is adequate, at least 8 years, discarding variables with insufficient memory.

(b) Combine multi frequency variables ie. monthly and daily series.

The series should be represented as monthly back through time but updated on a a daily/minutely basis.

(c) Determine the stationarity of the variable.

‘NS’=non-stationary where the mean and variance is changing ie. production index

‘S’=stationary meaning that the mean and variance are constant ie. interest rates

(d) Determine the seasonality of the variables.

Seasonality only applies to economic releases and market price variables are classified as ‘sa’(are deemed to be seasonally adjusted for the purposes of the formulae below)

Economic releases are broken up into the following types:

‘sa’=seasonally adjusted

‘nsa’=non-seasonally adjusted

This information will be used later to determine the correct transformation.

(e) Calculate the value of the bullrun_identifier based on its stationarity and seasonality

Please note that the c in the steps below is equal to the underlying ecowin code or formulae.

(i) if it is a market variable, regardless or stationarity or seasonality or if economic variable and is stationary then apply the following formula: BULLRUN_IDENTIFIER=c

(ii) if the economic variable is non-stationary and seasonally adjusted then apply the following formula: BULLRUN_IDENTIFIER=$d(c,6)

(iii) if the economic variable is non-stationary and non-seasonally adjusted then apply the following formula: BULLRUN_IDENTIFIER=$d(c,12)

(f) Using the bullrun_identifier a calculate the state of the variable going back through time for the period Jan. 1, 1993 to Dec. 30, 2000 using the following steps

The ‘STATE’ of the variable can be determined as follows:

If $m($h(bullrun_identifier,6),3)>=0

then STATE=1 (rising)

Else STATE=−1 (falling)

(g) These are the Basic Transformations used in the above formulae.

$d (a,12)=[(at+12−at/at)−1]×100

$d (a,6)=[(at+6−at)/at−1]×100

$h (a,12)=at+12−at

$h(a,6)=at+6−at

2) Eliminate Coincident Variables

In step (1) we calculated the historical ‘STATE’ for each bullrun-identifier for the last seven years. As some of these variables will be rising and falling at the same time, a coincidence programme was developed to avoid double-counting. If the coincidence (defined as two variables that give the same signal at time t) is greater than 67%, then that variable is eliminated on the basis that it is adding no new information.

C. Coefficient Sensitivity Calculation

Each macro variable was tested for its propensity to predict subsequent relative out performance for each of the 10 Sectors and 59 Industries outlined in Table 3, and the five regions outlined in Table 4 below.

TABLE 3
The Global MSCI Sectors and Industry breakdown

| | | |
|---|---|---|
| 1. ENERGY | 4. HEALTH CARE | 8. CONSUMER |
| Energy Equipment | Health Care Equip | DISCRETIONARY |
| & Services | & Supplies | Auto Components |
| Oil & Gas | Health Care | Automobiles |
| 2. MATERIALS | Providers & Services | Leisure Equipment & |
| Chemicals | Biotechnology | Products |
| Construction | Pharmaceuticals | Textiles & Apparel |
| Materials | 5. FINANCIALS | Hotels Restaurants & |
| Containers & | Banks | Leisure |
| Packaging | Diversified | Media |
| Metals & Mining | Financials | Distributors |
| Paper & Forest | Insurance | Internet & Catalog Retail |
| Products | Real Estate | Multiline Retail |
| 3. INDUSTRIALS | 6. CONSUMER | Specialty Retail |
| Aerospace & Defense | STAPLES | 9. INFORMATION |
| Building Products | Food & Drug Retailing | TECHNOLOGY |
| Construction & | Beverages | Internet Software & |
| Engineering | Food Products | Services |
| Electrical Equipment | Tobacco | IT Consulting & Services |
| Industrial | Household Products | Software |
| Conglomerates | Personal Products | Communications |
| Machinery | 7. UTILITIES | Equipment |
| Trading Companies & | Electric Utilities | Computers & Peripherals |
| Distributors | Gas Utilities | Electronic Equip & |
| Commercial Services | Multi-Utilities | Instruments |
| & Supplies | Water Utilities | Office Electronics |
| Air Freight & | | Semiconductor Equip & |
| Couriers | | Products |
| Airlines | | 10. TELE- |
| Marine | | COMMUNICATION |
| Road & Rail | | SERVICES |
| Transportation | | Diversified Telecomm |
| Infrastructure | | Services |
| | | Wireless Telecomm |
| | | Services |

TABLE 4
The Global Regional breakdown

North America
Japan
Pacific ex-Japan
United Kingdom
Europe Ex-United Kingdom

The process for coefficient calculation is outlined below.

1) Calculate Sensitivity of the Variable to the Target Relative Indices

The coefficient sensitivity is calculated as the performance in the subsequent month of each relative index when the macro variable is rising minus the performance of each relative index when the macro variable is falling. This difference is defined as the coefficient sensitivity and one will exist for each. Calculate a coefficient sensitivity each relationship pair. By this we mean a pair consisting of a macro variable and a market relative index (10 Sectors, 58 Industries, and 5 regions, giving a total of 73 relative indices).

2) Eliminate Unreliable Relationships

To avoid including variables purely on the basis of one-off large movements that may skew the magnitude of the coefficient a reliability test was applied. The reliability of each relationship is measured by calculating the percentage of times that the macro variable gave you the correct signal for the subsequent month's relative performance.

3) Matrix of Important Relationships

Those relationships (coefficients) that were deemed to be important in point 1) above and survived the reliability test were aggregated into a matrix.

D. Calculation of Scores for Each Relative Index Group

Applying the matrix calculated in Section C to the current state of the macro variables, the current readings for each of the relative index groups can be calculated. The four steps below explain the steps.

1) Calculate the Maximum Scores

Calculate the maximum absolute score (total coefficient sensitivity) for each of the 73 relative market indices. In effect this gives the maximum coefficient reading, if every macro variable was favouring the selected relative market index.

2) Calculate Current Score

Calculate the actual score by multiplying the current state of each macro variable (ie. rising 1, falling −1) through the coefficients matrix. Summing the total of these multiplications gives the current score.

3) Calculate Current Adjusted Score

Is calculated by dividing the current score calculated in 2) by the Maximum Score calculated in 1) and multiply by 100.

4) Weighting the Macro Effects

As every stock group will have three separate effects (ie. Sector, Industry and Region) these need to be weighted to give a score for each stock group between −100 and 100. An example of a stock group is Information Technology, Communication Equipment, Europe ex-UK. This group includes companies like Nokia and Ericsson.

The weighting could be as follows:

Sectors: 40%

Industry: 40%

Country: 20%

This reflects the fact that we found less macro variables that had strong ‘regional’ relationships and so our level of confidence is higher for the sector and industry readings and the weights should reflect this.

E. Calculation of Stock Scores

Now that we have a score between −100 and 100 for each stock group we need to select stocks to buy and sell within each group. The first step is to calculate 3 correlations for each stock, representing the stock's relationship with its Sector index, Industry index and Region index. The correlation took the form of a relative return comparison to make it consistent with the coefficient generation process outlined in the previous steps. The correlations are calculated over the last five years and the mathematics is as follows:

$$Correlation [ \$ d ( \frac{Stock A}{MSCI Index} , 3 ) \$ d ( \frac{Sector of Stock A}{MSCI Index} , 3 ) ]$$

The process was repeated for the industry and region calculations. Please note, to avoid generating counter-intuitive trades, where the correlation of any stock with the designated sector was negative, we set it to zero so that it would have no effect.

The final step was to calculate the macro score for each stock. We did this by multiplying each stock's relative correlation with its sector by that particular sector's macro score and repeated the process for its industry macro score and region macro score. These three scores are then added together to arrive at a ‘macro’ score for each stock which in theory should range between −100 and 100. The stocks then appear on the Bullrun site where the highest numbers represents the strongest ‘buys’ and the lowest (negative) numbers represent the strongest ‘sells’.

Programme Specifications for the Macroeconomic Strategy

Update Status Program

Latest Values Program

Combine Coefficients

Write to RDBMS

File containing the definition of approximately 900 market and macro variables

File containing the definition of the coefficients for each of the market variables

FAME database containing the Consensus Expectation Table.

C. Project Definition

The project principally relates to the calculation of a collection of coefficients that will be used for macro-economic rankings and rule generation.

This following programmes will produce continuous updates in the 900 long array of latest values and associated items with Bullrun's 900 market and macro variables.

C.1. Bullrun Identifier databases

The following databases are used to store the bullrun identifier information.

Bullrun_id_hist: This stores a history of Bullrun identifiers, states and coefficient totals.

Bullrun_id_today: This contains a collection of parallel CASE series containing information about the latest value of the Bullrun Identifiers, thresholds and coefficient set.

Bullrun_coeff: The definition of the basic coefficient sets.

1. Data Model for the Bullrun ID FAME databases

BULLRUN_ID_HIST

This database only contains time series. The calculated bullrun identifiers are the principal series stored in BULLRUN_ID_HIST.

The Bullrun Identifiers correspond to transformed series. The time series will be placed in Bullrun_id_hist. The time series will be given the same names as the corresponding bullrun identifier. A history of the states of the Bullrun identifiers will be stored in series with names of the form:

<Bullrun Identifier>.ST e.g. STIR_TBIL_USA.ST

BULLRUN_ID_TODAY

This database only contains CASE series. All the CASE series are parallel, each case point will contain the information pertaining to single bullrun identifier.

| | | Updating |
|---|---|---|
| Item | Description | Programme |
| %BULLRUN_ID | The name of the | Flat file |
| | Bullrun ID | |
| %DEFINITION | The expression of | Flat file |
| | the Bullrun ID | |
| | in terms of existing | |
| | FAME series | |
| %LATEST_VALUE | The value of the | Lastest Values |
| | last observation of | Programme |
| | the calculated | |
| | Bullrun ID | |
| %RIC | The RIC code of | Flat file |
| | the underlying | |
| | ecowin identifier. | |
| | Note, only the | |
| | primary market data | |
| | will have an ecowin | |
| | code. | |
| %VARIABLE_TYPE | 1 for primary | Flat file |
| | market data, 2 for | |
| | compound market | |
| | data, 10 for primary | |
| | macro data, 11 for | |
| | compound macro | |
| | data | |
| %STATIONARITY | S or NS | Flat file |
| %SEASONALITY | Sa or nsa | Flat file |
| %ECOWIN2 | Ecowin code of a | Flat file |
| | daily series to be | |
| | used to update the | |
| | latest value of the | |
| | monthly series | |
| %IS_MULTI_COUNTRY | Boolean. Whether | Flat file |
| | series is multi | |
| | country. | |
| %CONSENSUS_LOWER_{—} | Consensus lower | Update Thresholds |
| EXPECTION_THRESHOLD | expectation | Program |
| | threshold | |
| %CONSENSUS_UPPER_{—} | Consensus lower | Update Thresholds |
| EXPECTION_THRESHOLD | expectation | Program |
| | threshold | |
| %LOWER_{—} | The lower | Update Thresholds |
| EXPECTATION_{—} | expectation | Program |
| THRESHOLD | threshold | |
| %UPPER_EXPECTATION_{—} | The upper | Update Thresholds |
| THRESHOLD | expectation | Program |
| | threshold | |
| %LOWER_STATUS_{—} | The lower status | Update Threshold |
| THRESHOLD | threshold | Program |
| %UPPER_STATUS_{—} | The upper status | Update Threshold |
| THRESHOLD | threshold | Program |
| %EXPECTATION_{—} | The expectation | Set Status |
| TIMESTAMP | timestamp | Program |
| %STATUS_TIMESTAMP | The status | Set Status |
| | timestamp | Program |
| %COEFF_TOTAL_M | The summed | Combined |
| | minutely | Coefficients |
| | coefficients | |
| %COEFF_TOTAL_H | The summed | Combine |
| | hourly coefficients | Coefficients |
| %COEFF_TOTAL_D | The summed | Combine |
| | daily coefficients | Coefficients |
| %COEFF_TOTAL_W | The summed | Combine |
| | weekly coefficients | Coefficients |
| %STATE | The current state | Set Status |
| | (−1,0 or +1) | Program |
| %EXPECTATION | The current | Set Status |
| | expectation (−1,0 or | Program |
| | +1) | |
| %STATE_NEW_CHANGE | Whether the state | Set Status |
| | is new | Program/Update |
| | | Thresholds |
| %EXPECTATION_NEW_{—} | Whether the | Set Status |
| CHANGE | expectation is new | Program/Update |
| | | Thresholds |

BULLRUN_ID_COEFF

This database contains CASE series and time series.

Case Series

For a particular bullrun identifier <BULLRUN_ID>(e.g. STIR_TBIL_USA) the database contains the following CASE series. These will be populated by one off load from a flat file (provided by Bullrun).

| | |
|---|---|
| <BULLRUN_ID>.COEFF_UP | The set of coefficients corres- |
| | ponding to a Bullrun ID being |
| | above expectations or in a |
| | rising state |
| <BULLRUN_ID>.COEFF_FLAT | The set of coefficients corres- |
| | ponding to a Bullrun ID being |
| | within expectations or in a |
| | flat state |
| <BULLRUN_ID>.COEFF_DOWN | The set of coefficients corres- |
| | ponding to a Bullrun ID being |
| | below expectations or in a |
| | falling state |

Time Series

A history of the coefficient totals shall be stored as time series:

| | |
|---|---|
| <BULLRUN_ID>.COEFF_TOTAL_M | 15 minutely time series of |
| | the last 320 observations. |
| <BULLRUN_ID>.COEFF_TOTAL_H | Hourly time series of the |
| | last 320 observations |
| <BULLRUN_ID>.COEFF_TOTAL_D | Daily time series of the |
| | last 300 observations |
| <BULLRUN_ID>.COEFF_TOTAL_W | Weekly time series of the |
| | last 300 observations |

Note that the above time series are rolling time series and observations outside of the specified window will be deleted.

C.2. Programmes

1. Update Thresholds

This is run daily and consists of calculating expectation thresholds and states thresholds.

a) Update Expectation thresholds

1) Update the consensus expectation thresholds. This process will depend on the consensus expectation table being available in a FAME database supplied by Bullrun daily.

2) For those bullrun identifiers with consensus expectations, copy into result into %LOWER_EXPECTATION_THRESHOLD and %UPPER_EXPECTATION_THRESHOLD

3) Continue the process only with those Bullrun identifiers that have no consensus expectations

4) Calculate the volatility of daily changes in the market variables over a 20 day period in order to obtain default expectations thresholds. The expectations thresholds consist in the latest-value plus a standard deviation of the changes, and in the latest-value minus the standard deviation.

5) Calculate the volatility of monthly/weekly changes in the macro variables over an 18 day period in order to obtain default expectations thresholds. The expectations thresholds consist in the latest-value plus a standard deviation of the changes, and in the latest-value minus the standard deviation.

b) Update States Thresholds

For all variables calculate the states threshold using the steps specified in the Appendix.

2. Latest Values Update

The latest values update runs minutely and updates the current observation of the Bullrun identifiers (in BULLRUN_ID_HIST.db ) with the latest available data. Only the market variables and market compound variables are updated every minute. The latest value of every bullrun identifier is copied into the corresponding entry in the LATEST_VALUE CASE series in BULL_ID_TODAY.db.

The 800 macro and macro compound entries are updated only when an Ecowin XML update is received. This occurs once at some time during the month for each macro variable. The latest values program will search for a file in a particular directory containing the list of new updated Ecowin codes. Whenever such a file arrives, the specified Ecowin macro series will be updated together with all compound series. The processed file shall then be placed in an archive directory. Note: Because forward-fills require FAME to recognise the most recently updated macro variable among all the variables included in a given macro compound, we will have to create special forward-fill versions of our usual mathematical transformation functions. Examples for macro compounds within countries are:

| | | |
|---|---|---|
| fd12pmm | d12 − d12 − d12 | (forward d12 plus, minus, minus,) |
| (3 arguments) | | |
| fd6ppm | d6 − d6 − d6 | (forward d6 plus, minus, minus,) |
| (3 arguments) | | |
| fd12m | d12 − d12 | (forward d12 minus) |
| (2 arguments) | | |
| fd6m | d6 − d6 | (forward d6 minus) |
| (2 arguments) | | |
| fd12mN | d12 − N | (forward d12 minus number) |
| (2 arguments) | | |

An example for macro compounds across countries is:

fwsd12 (N arguments+weights table) d12 *W1, +d12 *w2

By using these special forward-fill functions we can use FAME formulae to handle such expressions as World M3=½ US M3+¼ Europe M3+¼ Japan M3 where FAME simply will forward-fill and evaluate Europe M3 before going on with the forward-fill and evaluation of World M3.

a) Bullrun Identifier Calculations

The Bullrun identifiers shall be calculated in a 3 step process.

Firstly, the formula/ecowin code specified in the % FORMULA_OR_CODE is evaluated using the latest available data. All transforms employ a forward filling of the original data.

1) The Seasonality/Stationarity dependent transform is applied:

| | | | Transform (c is the |
|---|---|---|---|
| Variable type | Seasonality | Stationarity | incoming series) |
| Market | SA | S | c |
| Market | SA | NS | c |
| Market | NSA | S | c |
| Market | NSA | NS | c |
| Economic | SA | S | c |
| Economic | SA | NS | $d(c,6) |
| Economic | NSA | S | c |
| Economic | NSA | NS | $d(c,12) |

2) The BULLRUN_ID_HIST is updated using the result from 2).

The % LATEST_VALUES entry is updated

The LATEST_VALUES are written to the RDBMS.

3. Set Status

The set status program runs minutely and compares the latest value of each Bullrun identifier to the state and expectation threshold and sets the corresponding status flag appropriately. The status flags are subject to minimum time before they are allowed to change again. Each time a status flag is changed the corresponding new change flag is set to 1.

The EXPECTATION_STATUS, EXPECTATION_NEW_CHANGE, STATES_STATUS and STATES_NEW_CHANGE is written to the RDBMS.

4. Combine Coefficients

The combine coefficients process runs minutely and produces a coefficient total for each Bullrun identifier.

The Set-Status programme will give 4 sets of results that can be used for ranking stocks. The set-status programme gives us four arrays:

a) Expectations Current Status Array. This gives (+1, 0, or −1) flags for all variables' comparisons to expectations.

b) Expectations New Change Array. This gives (1 or 0) flags for all variables having already changed in comparison to expectations.

c) States Current Status Array. This gives (+1, 0, or −1) flags for all variables' states.

d) Status New Change Array. This gives (1 or 0) flags for all variables having already changed states.

Expectations results are entirely independent of states results.

Each of the 900 variables has a first set of coefficients <BULLRUN_ID>.COEFF_UP corresponding to the +1 flag for above-expectations status or rising-state status. The same set of coefficients is used for both.

Each of the 900 variables has a second set of coefficients corresponding to the 0 flag for within-expectations status or flat-state status. <BULLRUN_ID>.COEFF_FLAT.

Each of the 900 variables has a third set of coefficients corresponding to the −1 flag for below-expectations status or falling-state status. <BULLRUN_ID>.COEFF_DOWN.

The combine-coefficients programme will use the four arrays and triplet sets of coefficients to produce for each variable a weighted coefficient set for the 15 minute, 15 hour, 15 day, and 15 week rankings.

Because the coefficients are additive, the programme can sum the sets for all variables to produce four total weighted coefficient sets corresponding to the 15 minute, 15 hour, 15 day and 15 week rankings. Once per minute, these four total sets can be multiplied through the stock table to give a macroeconomic ranking for all stocks in each of the four speeds.

The weightings for the four arrays and four speeds will be the following:

| | Minute | Hour | Day | Week |
|---|---|---|---|---|
| Expectations | 4 | 3 | 1 | 0 |
| New Change | | | | |
| Expectations Status | 2 | 2 | 0 | 0 |
| States New Change | 0 | 1 | 3 | 0 |
| States Status | 0 | 0 | 2 | 6 |

I. Minute Rankings

The weights table shows that for minute rankings, expectations-new-changes are the most important factor for each variable, followed by the variable's expectations-status itself. For each variable, the programme takes the coefficient set indicated by the variable's +1, 0, −1 expectations-status, and multiplies the set by the minute expectations-status weight. The programme then checks the variable's new-change flag of 1 or 0, and if the flag equals 1, multiplies the same coefficient set by the larger expectations-new-change weight. The sum of the two weighted coefficients sets represents the variables' contribution to minute rankings for macroeconomics.

II. Hour Rankings

Expectations-new-changes are most important for hourly rankings, followed by expectations-status, with a small contribution from states-new-changes. For each variable, the programme takes the coefficient set indicated by the +1, 0, −1 flag for expectations-status and multiplies the set by the hour expectations-new-change weight. The programme then takes the coefficient set indicated by the states-status +1, 0, −1 flag and, if the states-new-change flag is 1, multiplies that coefficient set by the hour states-new-change weight. The sum of the three weighted coefficient sets represents the variable's contribution to hour rankings for macroeconomics.

III. Day Rankings

States-new-changes are the most important factor for day rankings, followed by states-status, and a small contribution from expectations-new-changes. For each variable, the programme takes the coefficient set indicated by the +1, 0, −1 flag for states-status and multiplies the set by the day states-status weight. If the variables' state-new-change flag equals 1, then the same coefficient set is multiplied by the day states-new-change weight. If the variable's expectations-new-change flag equals 1, then the programme will take the coefficient set indicated by the variables expectation-status +1, 0, −1 and multiply it by the day expectations-new-change weight. The sum of the three weighted coefficient sets represents the variable's contribution to day rankings for macroeconomics.

IV. Week Rankings

States-status only is considered for week rankings. For each variable, the programme takes the coefficient set indicated by the variable's state-status +1, 0, −1 and multiplies the set by the week states-status weight.

For each of the four time period rankings, the programme will sum the adjusted coefficient sets for all 900 variables, to give four total coefficient sets.

Note: The foregoing describes what is happening for each of the minute, hour, day, and week macroeconomic rankings. The programme itself can be constructed with the following steps:

eflag=expectations status flag {=1, 0, −1}

sflag=states status flag {+1, 0, −1}

enewflag=expectations new change flag {1, 0}

snewflag=states new change flag {1, 0}

eswgt_m, eswgt_h, eswgt_d, eswgt_w=expectations status weight

sswgt_m, sswgt_h, sswgt_d, sswgt_w=states status weight

enwgt_m, enwgt_h, enwgt_d, enwgt_w=expectations new change weight

snwgt_m, snwgt_h, snwgt_d, snwgt_w=states new change weight

For each variable:

read the variable's coefficient sets (eflag) {one of 3 sets given by +1, 0, −1}

read the variable's coefficient sets (sflag) {one of 3 sets given by +1, 0, −1}

read the variable's enewflag {1 or 0}

read the variable's snewflag {1 or 0}

then multiply:

Variable's minute coefficient set=

coefficient sets (eflag)*eswgt_m

+coefficient sets (eflag)*enwgt_m*ennewflag

+coefficient sets (sflag)*sswgt_m

+coefficient sets (sflag)*snwgt_m*snewflag

Variable's hour coefficient set=idem using “_h” weights

Variable's day coefficient set=idem using “_d” weights

Variable's week coefficient set=idem using “_w” weights

Sum all variables' minute coefficient sets for the total minute coefficient (% COEFF_TOTAL_M), all variables' hour coefficients sets for total hour coefficient set (% COEFF_TOTAL_H), and so on for the day and week total coefficient sets. The % COEFF_TOTAL_M, % COEFF_TOTAL_H, % COEFF_TOTAL_D and % COEFF TOTAL_W will be written to RDBMS.

5. Write to RDBMS

The principal repository of the persistent data produced by the above programmes is FAME. However, it will be necessary to write some of the data generated by the above programmes to the RDBMS tables. The list of items to be written to the RDBMS are listed in each program description.

D. Appendix

These Specifications Should be Read in Conjunction with the Provided State_calc.xls File

Read in the following eight arguments:

(a) variable number

(b) bullrun_identifier

(c) ecowin code/formulae

(d) type of variable

(e) stationarity of the series

(f) seasonality of the series

(g) second ecowin code

(h) multiple-country variable

In the table below we have outlined three examples of the data provided in the state_calc.xls file.

| | | | | | | (g) | (h) |
|---|---|---|---|---|---|---|---|
| (a) | (b) | | (d) | | (f) | Second | Multi- |
| Variable | Bullrun | (c) | Type of | (e) | Sea- | Ecowin | country |
| Number | Identifier | Ecowin code/Formula | Variable | Stationarity | sonality | code | Variable |
| 1 | stir_tbil_usa | {usa14200} | 1 | S | sa | {usa14010} | 0 |
| 37 | indu_inpr_usa | {usa02005} | 10 | NS | sa | 0 | 0 |
| 893 | stir_tbil_g5x | $wgt({stir_tbil_usa,0.524 stir_tbil_jpn,0.17,stir_tbil | 2 | S | sa | 0 | 1 |
| | | _gbr,0.085,stir_tbil_deu,0.221 }) | | | | | |

****Steps****

(1) Check that the length of the series [(c)] is adequate

we need at least 9 years

if an adequate series does not exist then discard the variable, letting us know with some kind of tag

(2) Determine the 36 month rolling absolute average x month movement in the bullrun_identifier variable

ABS_AVE=$m(abs($h(bullrun_identifier,x)),36)

Where x=12 in the case of a type 10, stationary, non-seasonally adjusted variable (less than 3% of variables), and x=6 for all other variables

{calculate 36m average, 6m average in transformed variable}

(3a) Calculate frontiers for state changes in all variables. Use David's average 36m of 6m change and previously reported values for the variables.

For a stationary variable:

David's average<((last-a)/3+B/3+C/3)

{a=Mt-6, B=Mt-1−Mt-7, C=Mt-2 −Mt-8}

For a non-stationary variable:

David's average<((last/a−1)/3+B/3+C/3)

{a=Mt-6, B=Mt-1/Mt-7−1, C=Mt-2/Mt-8−1}

Solve for last>David's average, <David's average and in between to get

Rising state

falling state

flat state

{calculate actual frontiers for variable states}

(4) Using the bullrun_identifier a calculate the state of the variable going back through time for the period Jan. 1, 1994 to Sep. 9, 2000 using the following steps

The ‘STATE’ of the variable can be determined as follows:

If $m($h(bullrun_identifier,6),3)>0 and $m($h(bullrun_identifier,6),3)>abs_ave

then STATE=1 (rising)

If $m($h(bullrun_identifier,6),3)<0 and $m($h(bullrun_identifier,6),3)<−abs_ave

then STATE=−1 (falling)

Else STATE=0 (flat)

{compare current 6 m change state to 36 m average, 6 m change to assign state}

(5) Produce the ‘STATE’ results back through time in an agreed upon format

My suggestion is that you keep the variable names I have given you but add an “.st” suffix

{give the variable's state as a timeseries}

(6) These are the Basic Transformations and Bullrun functions that are contained in (c) above.

| Basic Transformations | | Functions | |
|---|---|---|---|
| (1) | $d12 (a) = | (1) | $ wgt (a, b, c, d, . . . i, j) = |
| | [(at − at + 12)/ | | a × b + c x d + . . . + |
| | at − 12 − 1] × 100 | | i x j |
| (2) | $d6 (a) = | (2) | $ diff (a, b) = |
| | =[(at − at − 6 )/ | | a − b |
| | at− 6 − 1] × 100 | | |
| (3) | $h12 (a) = | (3) | $ liq12 (a, b, c) = |
| | at − at − 12 | | $d12 (a) − $d12 (b/c) |
| (4) | $h6 (a) = | | |
| | at − at − 6 | | |
| (5) | $norm (a) | | |
| | [a − mave (a, 36)]/ | | |
| | [mstddev (a, 36)] | | |

4. Steps for the Earnings Strategy

i. This is a fractal strategy. The steps are adapted to shorter and longer time-scales by shortening and lengthening proportionally the intervals for the data measurements upon which the strategy is based. To generate this strategy's buy and sell signals for a security at a time-scale, proceed as follows:

a. Forward Earnings=current consensus estimate for the security's earnings growth for the next 12 months.

b. Moving Average=Moving average of the Forward Earnings over twelve data points.

c. Absolute Change=Change in the Forward Earnings from the previous data point.

d. Standard Deviation of Change=Standard Deviation of the Absolute Change.

e. Upgrades=number of analysts upgrading earnings growth forecasts for the security.

f. Downgrades=number of analysts downgrading earnings growth forecasts for the security.

g. Total Analysts=number of analysts whose forecasts make up the consensus.

h. Spread=Dispersion in analysts' forecasts for the security.

i. Spread t-1=Spread at the previous data point.

j. Tally1.

1) If Forward Earnings>Moving Average+Standard Deviation of Change, set (Tally1=1).

2) If Forward Earnings<Moving Average−Standard Deviation of Change, set (Tally1=−1).

3) Otherwise set (Tally1=0).

k. Tally2.

1) If Absolute Change>Standard Deviation of Change, set (Tally2=1).

2) If Absolute Change<−Standard Deviation of Change, set (Tally2=−1).

3) Otherwise set (Tally2=0).

1. Tally3.

1) If (Upgrades-Downgrades)/Total>Threshold, set (Tally3=1).

2) If Upgrades-Downgrades)/Total<−Threshold, set (Tally3=−1).

3) Otherwise set (Tally3=0).

m. Tally4.

1) If Absolute Change>0 and Spread>Spread t-1, set (Tally 4=1).

2) If Absolute Change<0 and Spread>Spread t-1, set (Tally 4=−1).

3) Otherwise set (Tally4=0).

n. Tally5.

1) Compare the Forward Earnings to the Forward Earnings decile rankings calculated for securities with the same capitalisation size (small, medium or large) in the same sector. The decile for the Forward Earnings by definition will range from 1 to 10.

2) Tally5=(decile−5)/2, using integer division.

o. Tally=Tally1+Tally2+Tally3+Tally4+Tally5.

p. The five measurements that are summed to give the Tally can be weighted.

ii. Generating Buy and Sell Signals from the Tally.

a. Step using the Tally.

1) Tally=current Tally.

2) Position t-1=1 if the security was owned, or −1 if the security was not owned at the previous data point.

3) Signal t=1 for a buy signal, 0 for no signal, or −1 for a sell signal at current data point.

4) If Position t-1 is not defined, the step has not been run for this security before. Initialize Position t-1 by setting (Position t-1=1) if the Tally is positive, or setting (Position t-1=−1) if the Tally is not positive.

5) If the security was owned at the previous data point (Position t-1=1), check whether its Tally is negative (Tally<0).

a) If so, generate a sell signal (set Signal t=1).

b) Otherwise generate no change (set Signal t=0).

6) If the security was not owned at the previous data point (Position t-1=−1), check whether its Tally is positive (Tally>0).

a) If so, generate a buy signal (set Signal t=1).

b) Otherwise generate no change (set Signal t=0).

c. The step using the Tally and changes in the Tally is obtained by using (Tally<0 and Tally Change<0), and (Tally>0 and Tally Change >0) in the step above. Tally Change=change in the Security Score over a statistically meaningful number of data points. The number of data points can be chosen to be consistent with signals given by Price Patterns. For example, measure the change in the Tally over 15 data points in order to be consistent with PricePatterns calculated over 15 data points.

iii. Time-scale adjustments. For shorter and longer time-scales use shorter and longer intervals between data points to calculate Absolute Changes. For minutely signals, use changes over a day. For hourly signals, use changes over a week. For daily signals use changes over a month. For weekly signals, use changes over a quarter.

Programme Specifications for the Earnings Strategy

Earnings-Ratios

Write to RDBMS

E. Project Definition

The project concerns the retrieval of IBES earnings estimates and combining the estimates with the latest Reuters and Siteserver data to produce various derived earnings related measures.

These measures will be pushed to the RDBMS for stock ranking purposes.

Wherever possible flash data will be used. Note that flash is available from the IBES Consensus Siteserver product. Flash data is only available for US and Canadian stocks.

E.1. Data Items

We need the following data items:

TABLE 1

| Item | Description |
|---|---|
| FWD_EPS_12M | Mean of the consensus estimates for 12 month |
| | forward EPS (see text) |
| FWD_EG_12M | FWD_EPS_12M/Current EPS i.e. mean of the |
| | consensus estimates for 12 month forward EPS/ |
| | Current EPS |
| FWD_PE_12M | Current Price/Mean of the consensus estimates for |
| | the 12 month forward EPS |
| FWD_PEG_12M | FWD_PE_12/FWD_EG_12M (i.e. Forward 12 |
| | month PE/Forward 12 month earnings growth) |
| EG_MAVE_12M | 12 month moving average of FWD_EG_12M (the |
| | forward earnings growth) |
| PE_MAVE_12M | 12 month moving average of FWD_PE_12M (the 12 |
| | month forward PE) |
| PEG_MAVE_12M | 12 month moving average of FWD_PEG_12M (the 12 |
| | month forward PEG) |
| EG_CHG_1W | 1 week change in FWD_EG_12M (the 12 month |
| | forward earnings growth estimate) |
| EG_CHG_1M | 1 month change in FWD_EG_12M (the 12 month |
| | forward earnings growth estimate) |
| EG_CHG_3M | 3 month change in FWD_EG_12M (the 12 month |
| | forward earnings growth estimate) |
| EG_CHG_1M_STDD | Standard deviation of EG_CHG_1M(1 month change in |
| EV | the 12 month forward earnings growth estimate) |
| EG_STDDEV_12M | Standard deviation of the estimates for the 12 month |
| | forward earnings growth (see text) |
| EPS_TOTAL_EST | Total number of EPS estimates |
| REVISION_RATIO | Upgrades-Downgrades/number of estimates (see text) |
| YIELD_12M | 1/FWD_PE_12M |
| EG_YIELD_12M | 1/FWD_PEG_12M |
| TALLY | Sum of the following 5 items TALLY_1 .. TALLY_5 |
| TALLY_1 | See text |
| TALLY_2 | See text |
| TALLY_3 | See text |
| TALLY_4 | See text |
| TALLY_5 | See text. Earnings growth decile |

E.2. Calculation Specification

Few of the required items are directly available from the IBES Consensus Summary Database. However, all items can be calculated either from just IBES data or a combination of IBES and the available equity pricing feeds (Reuters and FAME SiteServer).

The IBES items that shall be used are:

TABLE 2

| Item | Description |
|---|---|
| FY1_MEAN | Mean EPS estimate for Fiscal Year 1 |
| FY2_MEAN | Mean EPS estimate for Fiscal Year 2 |
| EP_12MO | Latest 12 Month EPS |
| ENDDATE_FYI | Fiscal Year 1 End Date |
| FY1_UP | Number of upgrades in the last month for FY1 |
| FY1_DOWN | Number of downgrades in the last month for FY1 |
| FY1_EST | Number of estimates for FY1 |
| FY2_UP | Number of upgrades in the last month for FY2 |
| FY2_DOWN | Number of downgrades in the last month for FY2 |
| FY2_EST | Number of estimates for FY2 |
| FY2_STDEV | Standard deviation of EPS estimations |
| | comprising FY2_MEAN |

The Items are Calculated as Follows

Consensus 12 month forward earnings per share {EPS}

FWD_EPS_{—}12M=(A*FY1_MEAN+(12-A)*FY2_MEAN)/12

where A=No. of months to the Fiscal Year 1 End Date

In FAME terms: A=ENDDATE_FY1-THISDAY(MONTHLY)

Consensus 12 Month Forward Earnings Growth {EG}

FWD_EG_{—}12M=(FWD EPS_{—}12M/EPS_{—}12MO−1)*100

Where EPS_{—}12MO is the latest 12 month EPS.

Consensus 12 Month Forward Price/earnings Ratio {PE}

PE_{—}12M=EPS_{—}12M/PRICE

Where PRICE is the latest price available from the Reuters feed.

For historical data PRICE will correspond to the CLOSE price from North American Pricing and

CLOSE.ADF for Global Pricing.

Standard Deviation of the Estimates for the 12 Month Forward Earnings Growth

We need to use the standard deviation for both FY1 and FY2

100*[(A/12)*FY1_SDEV+((12-A)/12)*FY2_SDEV]/EPS_{—}12MO

Revision Ratio

The revision ratio:

(A/12)*((FY1_UP-FY1_DOWN)/FY1_EST))+((12-A)/12)*((FY2_UP-FY2_DOWN)/FY2_EST))

Tally 1

I. Forward 12m earnings>(12 months mav+stddev absolute chge)=+1

Forward 12m earnings<(12 months mav−stddev absolute chge)=−1

Otherwise=0

In FAME terms:

FWD_EG_{—}12M>MAVE_EG_{—}12M+EG_CHG_{—}1M_STDDEV=+1

FWD_EG_{—}12M<MAVE_EG_{—}12M-EG_CHG_{—}1M_{—STDDEV=-}1

Otherwise=0

Tally 2

II. 1 month absolute change>stddev absolute chge=+1

1 month absolute change<stddev absolute chge=−1

Otherwise=0

In terms of the previously defined data items:

EG_CHG_{—}1M>+EG_CHG_{—}1M_STDDEV=+1

EG_CHG_{—}1M>+EG_CHG_{—}1M_STDDEV=−1

Otherwise=0

Tally 3

III. Upgrades-downgrades>threshold=+1 total

Upgrades-downgrades<−threshold=−1 total

Otherwise=0

In terms of the previously defined data items:

In REVISION_RATIO>threshold=+1

REVISION RATIO<−threshold=−1

Otherwise=0

The threshold shall assume the default value of 0.1

Tally 4

IV. 1 month absolute change>0 and spread t>spread t-1=+1

1 month absolute change<0 and spread t>spread t-1=−1

Otherwise=0

In terms of the previously defined data items:

EG_CHG_{—}1M>0 and EG_{STDDEV}_{—}12M[T]>EG_STDDEV_{—}12M[T−1]=+1

EG_CHG_{—}1M<0 and EG_STDDEV_{—}12M[T]<EG_STDDEV_{—}12M[T−1]=+1

Otherwise=0

Tally 5

V. Forward 12 months Earnings Growth decile, 1 to 10, per capitalisation size {small, medium, large}. The tally 5 is then (decile-5)/2 (integer division is used).

Calculate the deciles once per day for the three cap sizes. Compare flash for a stock's given cap size.

Tally

The numbers Tally 1 to Tally 5 are summed.

It should be clear how to calculate the other items listed in Table 1.

E.3. Data Model for the Earnings-Ratios for FAME/RDBMS databases.

a) EARNINGS HIST

All the items listed in Table 1 will be stored as daily time series. The naming convention is: <Stock identifier>.<Item>

The initial history will be built from the IBES Consensus Historical Database.

b) XREF

All the items listed in Table 1 will have their current value stored in parallel CASE series in the XREF database. The XREF database already exists and corresponds to the Stock table in the RDBMS.

c) RDBMS

The current value of a subset of the items listed in Table 1 will be exported to daily to the RDBMS:

TABLE 3
Item
FWD_EG_12M
FWD_PE_12M*
FWD_PEG_12M*
YIELD_12M*
EG_YIELD_12M*
TALLY

In addition the items in Table 2 marked with an * will be exported minutely to the RDBMS:

5. Steps for the Valuation Strategy

a. This is a fractal strategy. The steps are adapted to shorter and longer time-scales by shortening and lengthening proportionally the intervals for the data measurements upon which the strategy is based. To generate this strategy's buy and sell signals for a security at a time-scale, proceed as follows:

1) For market indices in each region, sector, and industry, (5 regions, 10 sectors, and 58 industry groups), calculate the market index's high value, central value and low value.

a) For each security in the market index, take the security's high, central and low value given by a valuation model. The model can be a dividend-discount model, cashflow-discount model, price/book-value model or any other model based on security fundamentals as long as it gives a high, central, and low value for the security.

b) For each security in the market index:

I. Divide the security's central value by its current price to obtain the percent distance from the current price to the central value. Multiply this distance by the security's percent capitalisation weight in the index to obtain the weighted distance.

II. Divide the security's high value by its central value to obtain the percent distance from the central value to the high value. Multiply this distance by the security's percent capitalisation weight in the index to obtain the weighted distance.

III. Divide the security's low value by its central value to obtain the percent distance from the central value to the low value. Multiply this distance by the security's percent capitalisation weight in the index to obtain the weighted distance.

c) By adding the weighted distances for all securities in the market index calculate the following:

Sum the weighted distances in step I. This gives the percent distance from the market index's current price to the market index's central value. Multiply the market index's current price by this distance to obtain the market index's central value.

Sum the weighted distances in step II. This gives the percent distance from the market index's central value to the market index's high value. Multiply the market index's central value by this distance to obtain the market index's high value.

Sum the weighted distances in step III. This gives the percent distance from the market index's central value to the market index's low value. Multiply the market index's central value by this distance to obtain the market index's low value.

d) Divide the market index's current price by its central value to obtain the percent distance from the market index's central value to its current price.

e) Subtract the market index's low value from the market index's high value to obtain the market index's value range. Subtract the market index's central value from the market index's current price and divide by the value range. This expresses the difference between the market index's central value and the market index's current price as a percentage of the market index's value range.

2) For each security in the investment universe, correlate its price movements to regional, sector, and industry price movements. Each security is classified by region, sector and industry. The price movements of each security in the investment universe are correlated with price movements of market indices corresponding to the security's region, sector, and industry. For each security, three correlation coefficients are obtained.

The first is the correlation between the security's performance relative to the world index and the security's regional market index performance relative to the world index.

The second is the correlation between the security's performance relative to the world index and the security's sector market index performance relative to the world index.

The third is the correlation between the security's performance relative to the world index and the security's industry market index performance relative to the world index.

The correlation coefficients range between +1 and −1. If negative correlation effects are not desired, correlation coefficients less than zero are set to zero.

3) For each security in the investment universe:

a) generate a percent distance valuation score by adding the following four figures:

The percent distance from the security's current price to its central value obtained by dividing the security's central value by its current price.

This percent distance for the security's regional market index, minus this percent distance for the security, weighted by the security's correlation coefficient with the regional market index.

This percent distance for the security's sector market index, minus this percent distance for the security, weighted by the security's correlation coefficient with the sector market index.

This percent distance for the security's industry market index, minus this percent distance for the security, weighted by the security's correlation coefficient with the industry market index.

b) Subtract the security's low value from its high value to obtain the security's value range. Subtract the security's central value from its current price and divide by the value range. This expresses the difference between the security's central value and its current price as a percentage of the security's value range. Generate a range-adjusted valuation score for the security by adding the following four figures:

The distance from the security's current price to its central value expressed as a percentage of the security's value range.

This percent distance for the security's regional market index, minus this percent distance for the security, weighted by the security's correlation coefficient with the regional market index.

This percent distance for the security's sector market index, minus this percent distance for the security, weighted by the security's correlation coefficient with the sector market index.

This percent distance for the security's industry market index, minus this percent distance for the security, weighted by the security's correlation coefficient with the industry market index.

c) In summing the four measurements used to generate the security's percentage distance valuation score, further weightings can be applied. In summing the four measurements used to generate the security's range-adjusted valuation score, further weightings can be applied.

4) Generate buy and sell signals from either valuation score by using the step described in the previous strategy for generating buy and sell signals from the earnings tally.

6. Steps for the Risk Strategy

This is a fractal strategy. The steps are adapted to shorter and longer time-scales by shortening and lengthening proportionally the intervals for the data measurements upon which the strategy is based. To generate this strategy's buy and sell signals for a security at a time-scale, proceed as follows:

1) For market indices in each region, sector, and industry, (5 regions, 10 sectors, and 58 industry groups), calculate the market index's high risk-metric, central risk-metric and low risk-metric.

a) For each security in the market index, take the security's high, central and low risk-metric given by a risk model. The risk models for the individual securities can be models based on the security's past volatility, interest-expense/cashflow models, debt/equity models or any model based on individual security fundamentals as long as it gives a high, central, and low risk-metric for the security.

b) For each security in the market index, the securities risk-metrics are expressed as an index. For example, take 1.25, 1.20, and 1.15 as the high, central and low risk-metrics for a security.

c) For each security in the market index, calculate the short-term risk-metric for the security by using short-term volatility in the security price, or by using short-term inputs into the risk model and taking the central risk-metric given by the model using short-term inputs as the short-term risk-metric. Express the security's short-term risk-metric as an index, for example, as 1.22.

d) For each security in the market index:

I. Divide the security's central risk-metric by its short-term risk-metric to obtain the percent distance from the short-term risk-metric to the central risk-metric. Multiply this distance by the security's percent capitalisation weight in the index to obtain the weighted distance.

II. Divide the security's high risk-metric by its central risk-metric to obtain the percent distance from the central risk-metric to the high risk-metric. Multiply this distance by the security's percent capitalisation weight in the index to obtain the weighted distance.

III. Divide the security's low risk-metric by its central risk-metric to obtain the percent distance from the central risk-metric to the low risk-metric. Multiply this distance by the security's percent capitalisation weight in the index to obtain the weighted distance.

e) By adding the weighted distances for all securities in the market index calculate the following:

Sum the weighted distances in step I. This gives the percent distance from the market index's short-term risk-metric to the market index's central risk-metric. Multiply the market index's short-term risk-metric by this distance to obtain the market index's central risk-metric.

Sum the weighted distances in step II. This gives the percent distance from the market index's central risk-metric to the market index's high risk-metric. Multiply the market index's central risk-metric by this distance to obtain the market index's high risk-metric.

Sum the weighted distances in step III. This gives the percent distance from the market index's central risk-metric to the market index's low risk-metric. Multiply the market index's central risk-metric by this distance to obtain the market index's low risk-metric.

f) Divide the market index's short-term risk-metric by its central risk-metric to obtain the percent distance from the market index's central risk-metric to its short-term risk-metric.

g) Subtract the market index's low risk-metric from the market index's high risk-metric to obtain the market index's risk-metric range. Subtract the market index's central risk-metric from the market index's short-term risk-metric and divide by the risk-metric range. This expresses the difference between the market index's central risk-metric and the market index's short-term risk-metric as a percentage of the market index's risk-metric range.

2) For each security in the investment universe, correlate its price movements to regional, sector, and industry price movements. Each security is classified by region, sector and industry. The price movements of each security in the investment universe are correlated with price movements of market indices corresponding to the security's region, sector, and industry. For each security, three correlation coefficients are obtained.

The first is the correlation between the security's performance relative to the world index and the security's regional market index performance relative to the world index.

The second is the correlation between the security's performance relative to the world index and the security's sector market index performance relative to the world index.

The third is the correlation between the security's performance relative to the world index and the security's industry market index performance relative to the world index.

The correlation coefficients range between +1 and −1. If negative correlation effects are not desired, correlation coefficients less than zero are set to zero.

3) For each security in the investment universe:

a) generate a percent distance riskscore by adding the following four figures:

The percent distance from the security's short-term risk-metric to its central risk-metric obtained by dividing the security's central risk-metric by its short-term risk-metric.

This percent distance for the security's regional market index, minus this percent distance for the security, weighted by the security's correlation coefficient with the regional market index.

This percent distance for the security's sector market index, minus this percent distance for the security, weighted by the security's correlation coefficient with the sector market index.

This percent distance for the security's industry market index, minus this percent distance for the security, weighted by the security's correlation coefficient with the industry market index.

b) Subtract the security's low risk-metric from its high risk-metric to obtain the security's risk-metric range. Subtract the security's central risk-metric from its short-term risk-metric and divide by the risk-metric range. This expresses the difference between the security's central risk-metric and its short-term risk-metric as a percentage of the security's risk-metric range. Generate a range-adjusted riskscore for the security by adding the following four figures:

The distance from the security's short-term risk-metric to its central risk-metric expressed as a percentage of the security's risk-metric range.

This percent distance for the security's regional market index, minus this percent distance for the security, weighted by the security's correlation coefficient with the regional market index.

This percent distance for the security's sector market index, minus this percent distance for the security, weighted by the security's correlation coefficient with the sector market index.

This percent distance for the security's industry market index, minus this percent distance for the security, weighted by the security's correlation coefficient with the industry market index.

c) In summing the four measurements used to generate the security's percentage distance riskscore, further weightings can be applied. In summing the four measurements used to generate the security's range-adjusted riskscore, further weightings can be applied.

d) A simpler calculation can be made by subtracting the security's central risk-metric from each of its regional indexes central risk-metric, sector indexes central risk-metric, and industry's central risk-metric. Each of these differences is weighted by the security's correlation coefficient with the index and summed.

4) Generate buy and sell signals from riskscores by using the step described in the previous strategy for generating buy and sell signals from the earnings tally.

7. Steps for Combining Strategies

Buy and Sell signals from one strategy at a time-scale are combined with buy and sell signals from one or more other strategies at that time-scale to give combined strategy buy and sell signals at the time-scale.

i. For each strategy at a time-scale, all securities in the universe will have a recommended ‘own’ position (+1) or ‘do not own’ position (−1) obtained from the strategy's buy and sell signals.

ii. If two strategies are summed, the maximum for ‘own positions’ for a security at any data point is (+2), and the minimum for ‘do not own’ positions is (−2). If three strategies are being combined, a security's maximum for ‘own’ positions is (+3) and its minimum for ‘do not own’ positions is (−3), and so on.

iii. For each security in the universe, at each data point over the period, sum the positions in the security given by the strategies to be combined. This gives the security's combined sum at each data point over the period.

iv. Buy and sell signals precede positions in a security by one data point. For each security, create buy and sell signals for the combined strategies:

1) Check whether the first data point in its combined sum is positive.

If so, initialise the buy and sell signal at the previous data point to (+1) buy. The security is a buy for the combined strategy.

Otherwise initialise the signal at the previous data point to (−1) sell. The security is a sell for the combined strategy.

2) For each subsequent data point in the signals:

If the security is a buy, check whether the combined sum at the next data point is at the minimum. If so, set the signal to (−1) sell and the security becomes a sell, otherwise set the signal to (0) no change.

If the security is a sell, check whether the combined sum at the next data point is at the maximum. If so, set the signal to (+1) buy and the security becomes a buy, otherwise set the signal to (0) no change.

Calculating Strategy Scores from Buy and Sell Signals

For any strategy at any time-scale, the securities in the universe can be scored. This score allows securities to be ranked from the best buy to the worst sell. A step for scoring securities is as follows:

1. Position=‘own’ (+1) or ‘do not own’ (−1) recommendation for the security given by the strategy at a time-scale.

2. Percent Price Change=percent price change for the security over a period corresponding to the time-scale. This is expressed as index. For example, a security that rose 50% over the period would have a Percent Price Change of 1.5. A security that fell 50% over the period would have a Percent Price Change of 0.5.

3. For each security check its recommended position according to the strategy. If the position is +1, the security's score is the reciprocal of the security's Percent Price Change. For example, the score for a security with a Percent Price Change of 1.5 is +0.667, and the score for a security with a Percent Price Change of 0.5 is +2.

If the position is −1, the security's score is the Percent Price Change multiplied by −1. For example, the score for a security with a Percent Price Change of 1.5 is −1.5, and the score for a security with a Percent Price Change of 0.5 is −0.5.

4. The security scores can be further weighted by criteria such as the time elapsed since the position change, the volatility of the security, and so on.

Portfolio Construction

1. The portfolio construction step uses three principal data sets:

i. A breakdown of the stockmarket index from which the portfolio will be constructed. Index cells are created for classifying the index's constituent stocks by region, sector and market capitalisation size. A breakdown into 3 regions (North America, Europe and Asia), 10 sectors (Financials, Consumer Discretionary, IT, Industrials, Healthcare, Consumer Staples, Telecommunications, Materials, Energy and Utilities) and 3 capitalisation sizes (Large, Medium and Small) would give 90 cells. Each index cell records the sum, as a percentage of the total index capitalisation, of the capitalisations of the index's constituent stocks that fall into the region, sector and capitalisation size represented by the cell. For example, for a World Stock Index, the sum of the capitalisations for North-American Financial Large stocks in the index may equal 9% of the index's total capitalisation.

ii. A universe list of securities for each cell. These universe lists contain all securities that are candidates for inclusion in the portfolio. The universe list of securities for each cell consists in the securities whose region, sector and capitalisation size matches that of the cell. Each security in the lists will have a score. The scores are derived from the investment strategy to be used as the basis for constructing the portfolio. Securities with buy signals will have positive scores, securities with negative signals will have negative scores. The lists also contain the capitalisation weights of each security expressed as a percentage of the total index capitalisation. The lists contain maximum and minimum portfolio percentage targets for each security.

iii. A list of current portfolio holdings for each index cell. The lists of securities currently held for each index cell also will have the current weight of each security expressed as a percentage of the total portfolio. These are the portfolio lists for each cell.

2. Portfolio construction is accomplished as follows:

i. Calculate the current index capitalisation percentages for each index cell. Rank the cells in descending order.

ii. Rank the securities in each universe list by the desired characteristic in descending order. The securities can be ranked by their capitalisation as a percentage of the total index capitalisation, by their score, or by a combination thereof.

iii. Calculate the maximum target weight for each security in the universe lists by multiplying its capitalisation percentage by a portfolio weighting coefficient. For example, given a security whose capitalisation is 3% of the index total capitalisation, and a weighting coefficient of 2, the maximum target weight for the security would be 6%. Maximum target weights for a security that are below a trade-size cutoff, for example less than 1%, are set to the trade-size cutoff.

iv. Calculate the minimum target weight for each security in the universe lists by dividing its capitalisation percentage by the portfolio weighting coefficient. For example, given a security whose capitalisation is 3% of the index total capitalisation, and a weighting coefficient of 2, the minimum target weight for the security would be 1.5%. Minimum target weights for a security that are below a trade-size cutoff, for example, less than 1%, are set to zero.

V. For each index cell calculate the current portfolio percentages of securities in the portfolio that correspond to the cell. Rank the list of portfolio holdings for the cell in descending order.

vi. Execute the process for generating sales by performing the following operations for each index cell.

a. Reduce or eliminate portfolio holdings that have sell signals. Move down the portfolio list of securities for the cell, determining whether the securities have a sell signal.

1) If the security has a sell signal,

i) Determine whether the current portfolio weight for the security is less than the twice the trade-size cutoff, for example, less than 2%. If so, post a sale for the entire position. (The use of the trade-size cutoff in this case is to avoid executing a sale that will leave a position in the stock that is less than the trade-size cutoff, for example, less than 1%.) Set the security's portfolio weight to zero, and remove the security from the cell's portfolio list.

ii) If the current portfolio weight for the security is more than twice the trade-size cutoff, then determine whether the security's portfolio weight is greater than its minimum target by more than the trade-size cutoff. If so, then post a sale for the security equal to the difference in its current weight and its minimum target. (The use of the trade-size cutoff in this case is to avoid executing a sell of less than the trade-size cutoff, for example, of less than 1% of the portfolio.) Set the security's portfolio weight to its minimum target. Otherwise, ignore the sell signal because the security's portfolio weight is not far enough above its minimum target to justify the expense of executing the sale.

2) If the security does not have a sell signal proceed to the next security in the portfolio list for the cell.

b. Reduce holdings of securities that have buy signals, but whose portfolio weights have risen above their maximum targets. Take the first security on the list and determine whether it has a buy signal.

1) If the security has a buy signal, then calculate whether the security's portfolio weight is greater than its maximum target by more than the trade-size cutoff. If so, then post a sell for the security equal to the difference between its current weight and its maximum target. Set the security's portfolio weight to its maximum target. Otherwise, leave the security's weight unchanged because the security's portfolio weight is not far enough above its maximum target to justify the expense of executing the sale.

2) If the security does not have a buy signal proceed to the next security in the portfolio list for the cell.

3) When the portfolio list for the cell is exhausted, exit the process and proceed to the next cell.

c. After the process for generating sales has run for all cells, determine whether there is excess cash in the portfolio.

1) Add the weights of all holdings in the portfolio. Subtract this sum from 100%. This difference is the total portfolio required purchase.

i) If the sum of the weights of all portfolio holdings is under 100% by more than the trade-size cutoff, then the process for generating buys will be executed. Existing portfolio positions will be increased where permitted by the trade-size cutoff, and new securities will be added to the portfolio where necessary.

ii) If the sum of portfolio weights is under 100% by less than the trade-size cutoff, the portfolio construction process is complete. (If this is the case at this point in the process, then no portfolio holdings at all were sold, and the portfolio will be unchanged.)

vii. Execute the process for generating purchases by determining which cells will receive the new securities. For each cell, take the cell's index capitalisation percentage and subtract the sum of the cell's portfolio holdings. The greater this difference, the more the cell is underweight in the portfolio. If the difference is negative, the cell's holdings are larger than its index total percentage, and the cell is overweight in the portfolio. Rank the cells from highest to lowest differences, that is to say from most underweight to most overweight. Perform the following operations for each cell beginning with the most underweight:

a. Decide whether holdings can be increased for securities that have buy signals and have portfolio weights below their maximum targets. Sum the portfolio weights for the cell's holdings, and subtract this figure from the cell's index capitalisation percentage. This difference is the cell's required purchase. For example, if portfolio holdings for the cell sum to 6%, and the index capitalisation percentage for the cell is 9%, then the cell's required purchase is 3%. If the cell's required purchase is greater than the trade-size cutoff, then begin the process of adding to existing portfolio holdings. For example, if the cell's required purchase is 3%, and the trade-size cutoff is 1%, begin adding to portfolio positions in the cell.

1) If the cell's required purchase is greater than the total portfolio required purchase, set the cell's required purchase equal to the total portfolio required purchase. (This will prevent the process from purchasing more than 100% of the portfolio.) Take the first security in the cell's holdings list and determine whether it has a buy signal.

2) If the security has a buy signal, determine whether the security's portfolio weight is under its target maximum by more than the trade-size cutoff. Subtract the security's portfolio weight from its target maximum. This difference is the security's required purchase.

i) If the security's required purchase is greater than the trade-size cutoff, the process will buy more of the security. If the security's required purchase is greater than the cell's required purchase, set the security's required purchase equal to the cell's required purchase. (This will prevent the process from purchasing more than the cell's required purchase.) Post a buy for the security equal to the security's required purchase. Set the security's portfolio weight to the sum of its current weight and the additional purchase. Reduce the total portfolio required purchase and the cell's required purchase by the amount of the additional purchase. (These amounts all are percentages of the portfolio.)

ii) If the security's required purchase is less than the trade-size cutoff, leave the security's weight unchanged because the security's portfolio weight is not far enough below its maximum target to justify the expense of executing the purchase.

3) If the security does not have a buy signal, proceed to the next security in the portfolio list for the cell.

4) The process of adding to existing portfolio positions will continue until the cell's required purchase is less than the trade-size cutoff, or the cell's list of holdings is exhausted.

b. Decide whether to add new securities to the cell. If the portfolio list for the cell is exhausted, and the sum of the portfolio weights still is under the cell's total index percentage by more than the trade-size cutoff, then begin the process of adding new securities to the portfolio.

1) Calculate the percentage needed to bring the sum of portfolio holdings for the cell up to the index capitalisation percentage for the cell. This is the cell's required purchase.

2) If the cell's required purchase is greater than the trade-size cutoff, the process will add new securities to the cell. If the cell's required purchase is greater than the total portfolio required purchase, set the cell's required purchase equal to the total portfolio required purchase. (This will prevent the process from purchasing more than 100% of the portfolio.)

i) From the universe list corresponding to the cell take the first security that is not held in the portfolio. Determine whether it has a buy signal.

a) If the security has a buy signal, it will be added to the cell's portfolio holdings. The security's required purchase is equal to its maximum target. If the security's required purchase is greater than the cell's required purchase, set the security's required purchase to the cell's required purchase. For example, if the security's required purchase is 4%, and the cell's required purchase is 3%, set the security's required purchase to 3%. (This will prevent the process from adding more than the cell's required purchase.) Post a buy order for the security's required purchase. Add the security to the cell's portfolio holdings list. Set the security's portfolio weight equal to the buy order. Reduce the total portfolio required purchase and the cell's required purchase by the additional purchase. (These amounts all are percentages of the portfolio.)

b) If the security does not have a buy signal, then proceed to the next security in the universe list for the cell.

3) When the difference between the sum of portfolio holdings for the cell and the cell's index capitalisation percentage is less than the trade-size cutoff, the process exits to go on to the next cell. For example, with a trade-size cutoff of 1%, whenever the portfolio holdings for the cell sum to more than 8% for a cell with an index capitalisation percentage of 9%, the process exits.

4) The universe list could be exhausted before enough new shares have been added to the cell to bring the cell's required purchase below the trade-size cutoff. In that case, there are no more potential purchases for this cell, and the process exits to go on to the next cell. p1 c. After the process for generating purchases has run for all cells, determine whether there is excess cash in the portfolio.

1) Add the weights of all holdings in the portfolio. If this sum is under 100% by more than the trade-size cutoff, then further new securities will be added to the portfolio.

i) Subtract the sum of the weights of all portfolio holdings from 100%. Divide this difference by the trade-size cutoff and round down to an integer. This is the number of further new stocks that will be added to the portfolio. For instance, if the weights of all portfolio holdings sum to 95.5%, and the trade-size cutoff is 1%, then the difference from 100% is 4.5%, and the number of new stocks will be 4. The weightings for each will be equal to the trade-size cutoff.

ii) Determine which cells will receive the new securities.

a) For each cell, take the cell's index capitalisation percentage and subtract the sum of the cell's portfolio holdings. The greater this difference, the more the cell is underweight in the portfolio. If the cell's portfolio holdings are larger than its index total percentage, the difference is negative, and the cell is overweight in the portfolio.

b) Rank the cells from highest to lowest differences, that is to say from most underweight to most overweight.

iii) Add new securities to the cells.

a) Begin with the top-ranked cell.

I. From the universe list corresponding to the cell take the first security that is not held in the portfolio. Determine whether it has a buy signal.

A) If the security has a buy signal, post a purchase equal to the trade-size cutoff. Set the security's portfolio weight to the trade-size cutoff, for example, to 1%. Add the security to the cell's portfolio holdings list. Reduce by 1 the number of new securities to be added to the portfolio, and if there are still securities to be added, go on to the next cell. If the number of new securities to be added is zero, the portfolio construction process is complete.

B) If the security does not have a buy signal, go to the next security in the universe list for this cell.

II. If the universe list for this cell is exhausted before a buy signal is encountered, go on to the next cell, leaving unchanged the number of securities to be added to the portfolio.

b) If the number of securities to be added to the portfolio greater than zero, proceed to the next cell. Otherwise, the portfolio construction process is complete.

c) If there are still new securities to be added to the portfolio, but universe lists for all cells are exhausted before encountering a buy signal, then there are not enough suitable candidates to finish the portfolio purchases. The cash position remains in the Portfolio. the portfolio constituent process is complete.

2) If there is no cash in the portfolio the portfolio construction process is complete.

3. Adapting the portfolio tracking error.

The probable difference between the portfolio's performance and that of the reference market index used in its construction can be adapted as follows:

b. The greater the weighting coefficient, the larger the expected difference in performance.

c. The less capitalisation weights are weighted for ranking in the universe lists and the more security scores are weighted, the greater the difference in performance.

d. The larger the trade-size cutoff, the greater the difference in performance.

e. Each or all of these criteria can be changed in an iterative fashion to create portfolios whose probable performance will be closer and closer to the reference portfolio.

Combining Portfolios Given by Difference Strategies into a Single Portfolio

The portfolio holdings given by two or more strategies can be combined into a single portfolio in two ways:

1. Add together the holdings from all portfolios, eliminate holdings less than the trade-size cutoff divided by the number of portfolios, and re-weight the remaining holdings to 100%, in proportion to their summed holding sizes.

2. Alternatively, re-create the universe lists using only the securities in the portfolios to be combined, and run the portfolio construction step as before.

Having now described the preferred embodiment of the present invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, equivalents or similar purpose, unless expressly stated otherwise. Therefore, numerous other embodiments of the modifications thereof are contemplated as falling within the scope of the present invention as defined by the appended claims and equivalents thereto. The headings are used only to assist the reader and is not to be interpreted to limit the present invention in any way.

I claim:

1. A method for identifying and selecting an investment item comprising the steps of:
receiving a plurality of investment items;
causing a strategy to be selected to apply to such plurality of investment items;
causing a time-scale to be selected for use by the strategy;
applying the strategy to the plurality of investment items over the time-scale;
generating an investment signal for each investment item as a result of applying the strategy to at least one investment item;
transmitting the investment signal to a display device.

2. A method for identifying and selecting an investment item comprising the steps of:
receiving a plurality of investment items;
causing a plurality of strategies to be selected to apply to such plurality of investment items;
causing a time-scale associated with each strategy to be selected for use by the strategy;
applying each strategy to the plurality of investment items over the associated time-scale;
generating an investment signal for each investment item for each strategy as a result of applying each strategy to at least one investment item;
applying a weight to each investment signal for an investment item;
generating an aggregated investment signal by aggregating all weighted investment signals for an investment item;
transmitting the aggregated investment signal to a display device.

3. A system for identifying and selecting an investment item comprising:
receiver to receive a plurality of investment items;
transmitter cause a strategy to be selected to apply to such plurality of investment items;
transmitter to cause a time-scale to be selected for use by the strategy;
processor applying the strategy to the plurality of investment items over the time-scale and to generate an investment signal for each investment item as a result of applying the strategy to at least one investment item;
transmitter to transmit the investment signal to a display device.
